(19) United States
(12) Patent Application Publication
(10) Pub. No.: US 2026/0202904 A1
(43) Pub. Date: Jul. 16, 2026

(54) INFORMATION PROCESSING DEVICE AND INFORMATION PROCESSING METHOD

(71) Applicant: SONY GROUP CORPORATION, TOKYO (JP)

(72) Inventors: TAKASHI MIURA, TOKYO (JP); TOSHIJI SUZUKI, TOKYO (JP); YOICHI KATAGIRI, TOKYO (JP); REYNAN RODRIGUEZ VALENCIA, TOKYO (JP)

(21) Appl. No.: 19/135,045

(22) PCT Filed: Oct. 20, 2023
(86) PCT No.: PCT/JP2023/037977

§ 371 Date: Jun. 2, 2025

(30) Foreign Application Priority Data
Dec. 7, 2022 (JP) 2022-195501

(51) Int. Cl. G06F 3/01

(52) U.S. Cl. CPC G06F 3/011

(57) ABSTRACT

Provided are a device and a method capable of efficiently and accurately executing search processing for motion data similar to a user motion. A motion information extraction unit that extracts motion data search motion information from user motion information based on a detection value of a motion sensor worn by a user is included. The motion information extraction unit detects (p) search motion information start position identification pose and (q) search motion information end position identification pose or a set of these and a preliminary notification pose, and extracts motion information between the detected pose or the pose set as motion data search motion information. By applying the extraction result to search for motion data, it is possible to perform highly accurate data search based on motion not including extra motion.

### TECHNICAL FIELD

The present disclosure relates to an information processing device and an information processing method. More specifically, the present disclosure relates to an information processing device and an information processing method capable of performing efficient acquisition processing of motion data having a motion desired by a user from a large number of pieces of various motion data held by a server.

### BACKGROUND ART

In recent years, a game application (application), a virtual reality space application (metaverse application), or the like is used using various user equipment such as a PC, a smartphone, a game device, or VR goggles capable of allowing many users to observe a VR image (virtual reality image).

When a game application or a virtual reality space application (metaverse application) is used, for example, various characters are displayed on the display unit of the user device, and the user can operate a character by operating the user equipment.

Note that the character includes, for example, a virtual character in an application, an avatar that is a virtual image indicating the user, and the like.

The user can cause the character displayed on the display unit to perform various motions, for example, various motions such as jumping, walking, running, punching, or dancing, by operating a user interface (UI), a physical button, a switch, or the like displayed on the display unit of the user equipment.

However, the operation that the user can cause the character to execute is generally limited to an operation defined in advance in an application such as a game application. Therefore, for example, an original operation thought up by the user cannot be performed.

Note that there is also an application in which sensors are worn on the body of the user and a motion of the user obtained from sensor detection values is reproduced by the character, and in this case, the motion of the user itself is reflected on the character, and for example, when the motion of the user is slow, there is a problem that it is not possible to cause the character to execute an ideal high-speed action of the user, and it is not possible to reflect a motion that is difficult for the user to move on the character.

Note that, for example, Patent Document 1 (WO2018/123293 A1) discloses a configuration in which sensors are worn on a user and a motion of the user is analyzed.

### CITATION LIST

### Patent Document

Patent Document 1: WO2018/123293 A1

### SUMMARY OF THE INVENTION

### Problems to be Solved by the Invention

The present disclosure has been made in view of the above problems, for example, and provides an information processing device and an information processing method capable of efficiently acquiring motion data desired by a user from a large number of pieces of various motion data held by a server.

### Solutions to Problems

A first aspect of the present disclosure is an information processing device including a motion information extraction unit that extracts motion data search motion information from user motion information analyzed on the basis of sensor detection values of motion sensors worn on a plurality of parts of a body of a user, in which
the motion information extraction unit
detects identification poses of:
(p) search motion information start position identification pose; and
(q) search motion information end position identification pose,
from the user motion information, and extracts motion information between the detected identification poses as motion data search motion information.

Furthermore, a second aspect of the present disclosure is an information processing method executed in an information processing device, in which
the information processing device includes a motion information extraction unit that extracts motion data search motion information from user motion information analyzed on the basis of sensor detection values of motion sensors worn on a plurality of parts of a body of a user, and
the information processing method includes:
detecting, by the motion information extraction unit, identification poses of:
(p) search motion information start position identification pose; and
(q) search motion information end position identification pose,
from the user motion information, and extracting motion information between the detected identification poses as motion data search motion information.

Other objects, features, and advantages of the present disclosure will become apparent from the detailed description based on the embodiments of the present disclosure described later and the accompanying drawings. Note that, in the present specification, a system is a logical set configuration of a plurality of devices, and is not limited to one in which devices of respective configurations are in the same housing.

With a configuration of an embodiment of the present disclosure, a device and a method capable of efficiently and accurately executing search processing for motion data similar to a user motion are implemented.

Specifically, for example, a motion information extraction unit that extracts motion data search motion information from user motion information based on a detection value of a motion sensor worn by the user is included. The motion information extraction unit detects (p) search motion information start position identification pose and (q) search motion information end position identification pose or a set of these and a preliminary notification pose, and extracts motion information between the detected pose or the pose set as motion data search motion information. By applying the extraction result to search for motion data, it is possible to perform highly accurate data search based on motion not including extra motion.

With this configuration, a device and a method capable of efficiently and accurately executing search processing for motion data similar to a user motion are implemented.

Note that the effects described herein are merely examples and are not limited, and additional effects may also be provided.

### BRIEF DESCRIPTION OF DRAWINGS

FIG. 1 is a diagram describing configurations of an information processing system and an information processing device to which processing of the present disclosure is applicable and an outline of the processing.

FIG. 2 is a diagram describing a processing example of a user terminal that has received a search result in a motion data providing server.

FIG. 3 is a diagram describing a processing example of the user terminal that has received the search result in the motion data providing server.

FIG. 4 is a diagram describing a processing example of the user terminal that has received the search result in the motion data providing server.

FIG. 5 is a diagram describing a processing example using a search keyword as search request processing from the user terminal to the motion data providing server.

FIG. 6 is a diagram describing an example in which motion data search processing using keywords is difficult.

FIG. 7 is a diagram describing a wearing example of sensors for acquiring motion information of the user to be transmitted to the motion data providing server.

FIG. 8 is a diagram describing operation recording processing and transmission processing for motion data search by the user wearing sensors.

FIG. 9 is a diagram describing a problem that data unnecessary for motion data search processing is included in “recorded data” transmitted from the user terminal to the motion data providing server.

FIG. 10 is a diagram describing a problem that data unnecessary for motion data search processing is included in “recorded data” transmitted from the user terminal to the motion data providing server.

FIG. 11 is a diagram describing a configuration for solving a problem that data unnecessary for motion data search processing is included in “recorded data” transmitted from the user terminal to the motion data providing server.

FIG. 12 is a diagram describing an embodiment in which a search motion information area can be identified using a specific pose.

FIG. 13 is a diagram describing a processing example of generating and using motion data that enables identification of a search motion information area using a specific pose.

FIG. 14 is a diagram describing a processing example of generating and using motion data that enables identification of a search motion information area using a specific pose.

FIG. 15 is a diagram describing a processing example of generating and using motion data that enables identification of a search motion information area using a pose set including a plurality of poses.

FIG. 16 is a diagram describing a processing example of generating and using motion data that enables identification of a search motion information area using the pose set including the plurality of poses.

FIG. 17 is a diagram describing a processing example of generating and using motion data that enables identification of a search motion information area using the pose set including the plurality of poses.

FIG. 18 is a diagram describing an embodiment of executing motion data search processing based on a motion of a user wearing VR goggles.

FIG. 19 is a diagram describing the embodiment of executing motion data search processing based on a motion of the user wearing VR goggles.

FIG. 20 is a diagram describing the embodiment of executing motion data search processing based on a motion of the user wearing VR goggles.

FIG. 21 is a sequence diagram describing a communication sequence among a sensor worn by a user, a user terminal, and a motion data providing server.

FIG. 22 is a diagram illustrating a flowchart describing a processing sequence executed by the user terminal.

FIG. 23 is a diagram illustrating a flowchart describing a processing sequence executed by the user terminal.

FIG. 24 is a sequence diagram describing a communication sequence among a sensor worn by the user, the user terminal, and the motion data providing server.

FIG. 25 is a diagram illustrating a flowchart describing a processing sequence executed by the user terminal.

FIG. 26 is a diagram illustrating a flowchart describing a processing sequence executed by a motion data providing server. FIG. 27 is a diagram illustrating a flowchart describing a processing sequence executed by the motion data providing server.

FIG. 28 is a diagram describing a specific example of motion data purchase processing.

FIG. 29 is a diagram describing a specific example of the motion data purchase processing.

FIG. 30 is a diagram describing a specific example of the motion data purchase processing.

FIG. 31 is a diagram describing a specific example of the motion data purchase processing.

FIG. 32 is a diagram describing a specific example of the motion data purchase processing.

FIG. 33 is a diagram describing a specific example of the motion data purchase processing.

FIG. 34 is a diagram describing a specific example of the motion data purchase processing.

FIG. 35 is a diagram describing a specific example of the motion data purchase processing by a user wearing VR goggles.

FIG. 36 is a diagram describing a specific example of the motion data purchase processing by the user wearing the VR goggles.

FIG. 37 is a diagram describing a specific example of the motion data purchase processing by the user wearing the VR goggles.

FIG. 38 is a diagram describing configuration examples of a user terminal and an information processing device such as a motion data providing server.

FIG. 39 is a diagram describing a hardware configuration example of the information processing device of the present disclosure.

### MODE FOR CARRYING OUT THE INVENTION

Hereinafter, an information processing device and an information processing method of the present disclosure will be described in detail with reference to the drawings. Note that the description will be made in accordance with the following items.
1. Overview of Information Processing System to Which Processing of Present Disclosure Is Applicable and Problems Thereof
2. (First Embodiment) Embodiment Enabling Identification of Search Motion Information Area Using Specific Pose
3. (Second Embodiment) Embodiment Enabling Identification of Search Motion Information Area Using Set of Poses Including Plurality of Poses
4. (Third Embodiment) Embodiment of Executing Motion Data Search Processing Based On Action of User Wearing VR Goggles
5. Sequences of Processing Executed by Information Processing Device According to Present Disclosure
6. (Fourth Embodiment) Details of Motion Data Purchase Processing
7. Configuration Example of Information Processing Device 8. Example of Hardware Configuration of Information
Processing Device
9. Summary of Configuration of Present Disclosure

### 1. Overview of Information Processing System to Which Processing of Present Disclosure is Applicable and Problems Thereof

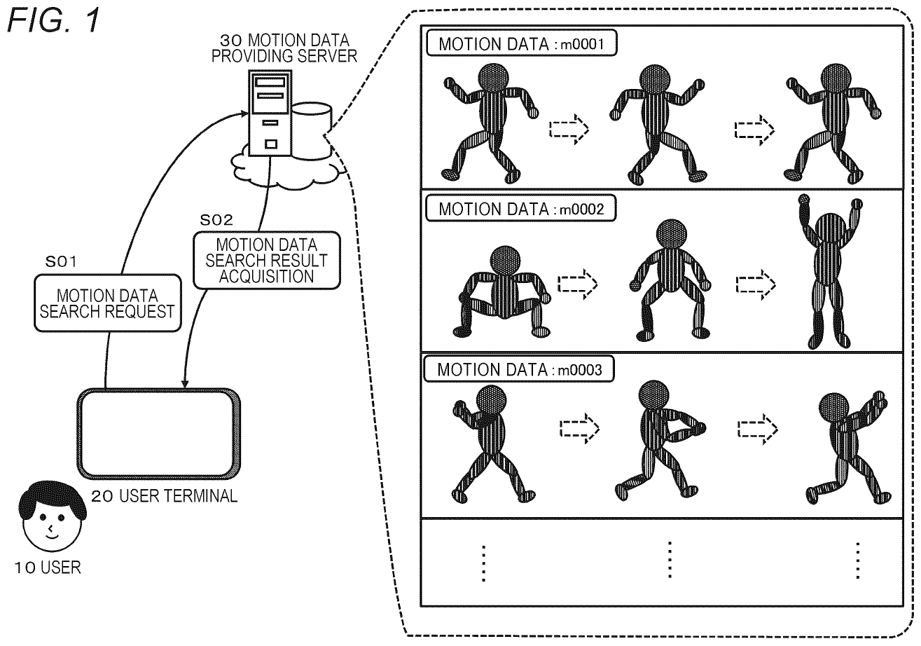

First, an overview of an information processing system to which processing of the present disclosure is applicable and problems thereof will be described with reference to FIG. 1 and subsequent drawings.

FIG. 1 is a diagram illustrating a configuration example of an information processing system to which processing of the present disclosure is applicable.

FIG. 1 illustrates a user terminal 20 such as a smartphone, which is an example of an information processing device used by a user 10, and a motion data providing server 30 capable of communicating with the user terminal 20 via a communication network such as the Internet.

The motion data providing server 30 is a server that stores a large number of pieces of motion data that are data defining various actions (motions) of a character. The motion data providing server 30 provides the user terminal 20 with motion data defining a motion desired by the user 10 in response to a request from the user terminal 20.

The motion data held by the motion data providing server 30 is, for example, data such as BVH data (BVH file). Biovision hierarchy (BVH) is one of file formats for motion capture used in 3DCG.

For example, by applying the motion data defined by the BVH data to a 3DCG character used in a game application or the like, the character can be caused to execute the action defined by the motion data.

FIG. 1 illustrates a plurality of examples of motion data held by the motion data providing server 30.

Motion data m0001 is motion data defining a dance action of alternately raising and lowering a hand and a foot.

Motion data m0002 is motion data defining a jump action.

Motion data m0003 is motion data defining a batting action.

In addition to these examples, the motion data providing server 30 stores a large number of pieces of motion data defining various different actions in a storage unit.

Note that the data format of the motion data held by the motion data providing server 30 is not limited to the above-described BVH data (BVH file) format, and other various data formats can be used.

Steps S01 to S02 illustrated in FIG. 1 are steps describing an example of a processing sequence in which the user 10 searches for and acquires motion data of an action desired by the user 10 from the motion data providing server 30 using the user terminal 20.

In step S01, the user 10 transmits a search request for motion data corresponding to a specific action from the user terminal 20 to the motion data providing server 30. For example, a search request for motion data indicating a jump action is transmitted.

Upon receiving the motion data search request from the user terminal 20, the motion data providing server 30 executes search processing for selecting motion data corresponding to an action matching the request of the user from a large number of pieces of motion data stored in the storage unit, and transmits the obtained search result to the user terminal 20 in step S02.

Note that the motion data transmitted to the user terminal 20 at this stage is data for preview of the motion data, and is, for example, simple moving image data having a data size smaller than that of the motion data body in the above-described BVH data (BVH file) format, a thumbnail image indicating a representative image in the motion data, or the like.

By the user 10 performing motion data purchase processing, the motion data body is transmitted from the motion data providing server 30 to the user terminal 20.

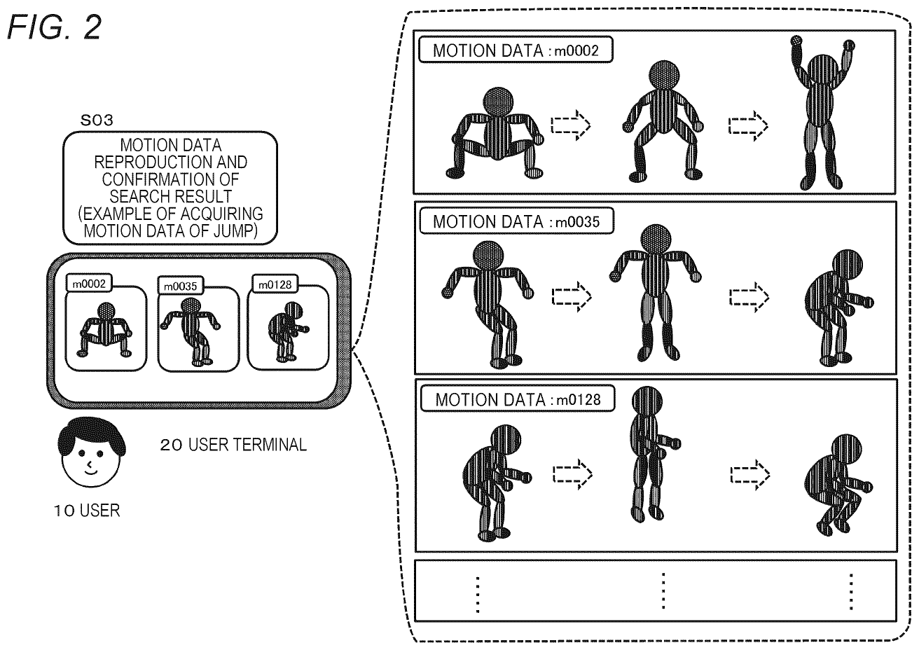

FIG. 2 is a diagram describing processing in the user terminal 20 that has received the search result.

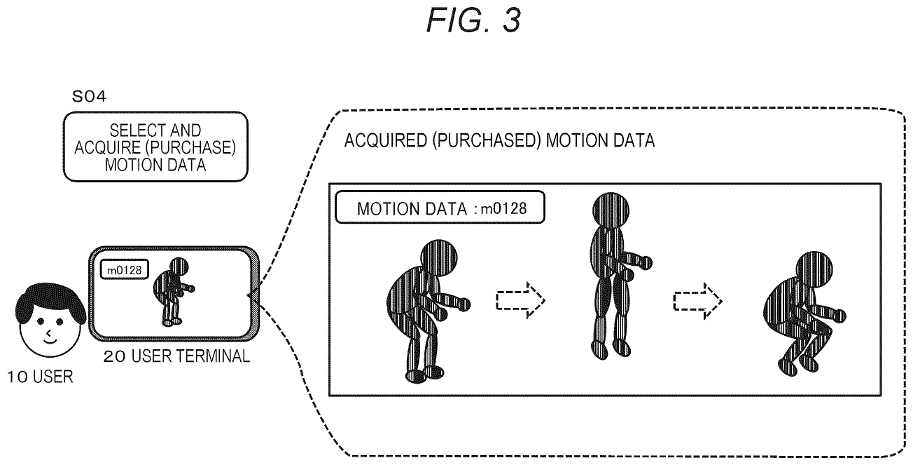

The example illustrated in FIG. 3 is a processing example in a case where a search request for motion data indicating the jump action is transmitted from the user terminal 20 to the motion data providing server 30, and the motion data providing server 30 transmits motion data indicating the jump action to the user terminal 20 as a search result.

The motion data providing server 30 transmits a plurality of pieces of motion data (m0002, m0035, m0128, . . .) indicating the jump action as the search result to the user terminal 20.

In step S03 illustrated in FIG. 2, the user terminal 20 reproduces a plurality of pieces of motion data (m0002, m0035, m0128 . . . ) indicating the jump action received from the motion data providing server 30 using the user terminal 20.

The user 10 confirms the reproduced image, and determines acquisition (purchase) of one piece of motion data.

For example, a purchase of the motion data m0128 is determined.

The user 10 executes communication with the motion data providing server 30 using the user terminal 20 to execute processing necessary for the purchase processing, for example, settlement processing, and the like, thereby purchasing the motion data m0128.

By this purchase processing, for example, motion data body data in the above-described BVH data (BVH file) format is transmitted from the motion data providing server 30 to the user terminal 20.

Note that the purchase price of the motion data varies depending on each piece of the motion data, and free motion data can also exist.

For example, it is possible to set a price of a batting motion of a famous player in the major league to be high, and a general batting motion to be provided for free.

In the present example, it is assumed that the user 10 has purchased motion data m0128 defining a jump action as illustrated in FIG. 3.

This motion data is, for example, data such as BVH data (BVH file) as described above. As described above, the motion data in the BVH format can be applied to, for example, a 3DCG character used in a game application or the like to cause the character to execute an operation corresponding to the motion data.

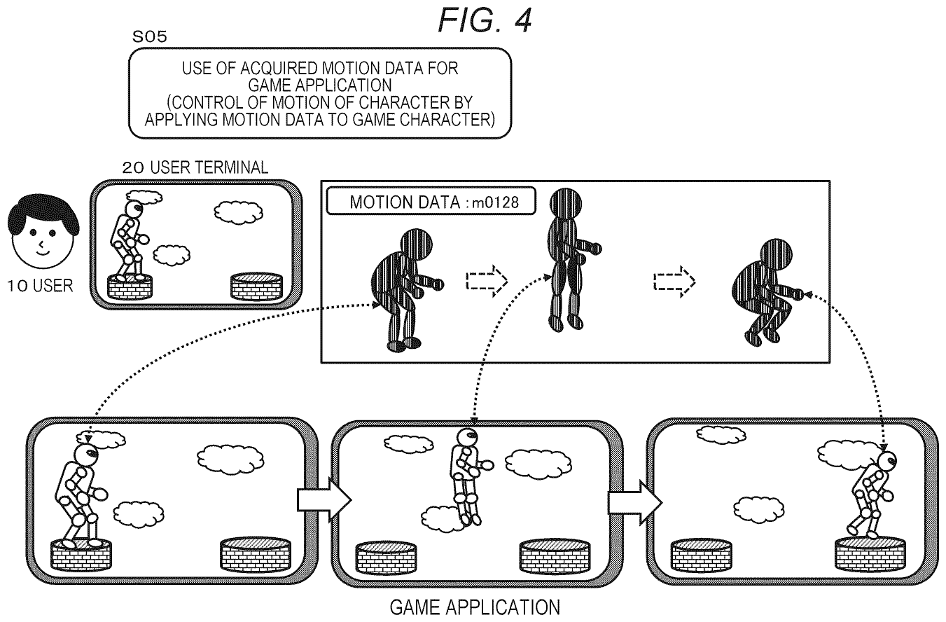

FIG. 4 illustrates an example in which the motion data (m0128) indicating the jump action purchased from the motion data providing server 30 is applied to the character of the game application executed on the user terminal 20.

As illustrated in FIG. 4, motion data application processing for the character enables the character to perform a motion similar to the motion data.

The processing example described with reference to FIGS. 1 to 4 is a processing example in which a search request for motion data indicating the jump action is transmitted from the user terminal 20 to the motion data providing server 30, and the motion data providing server 30 transmits a plurality of pieces of motion data indicating the jump action, which is the search result, to the user terminal 20.

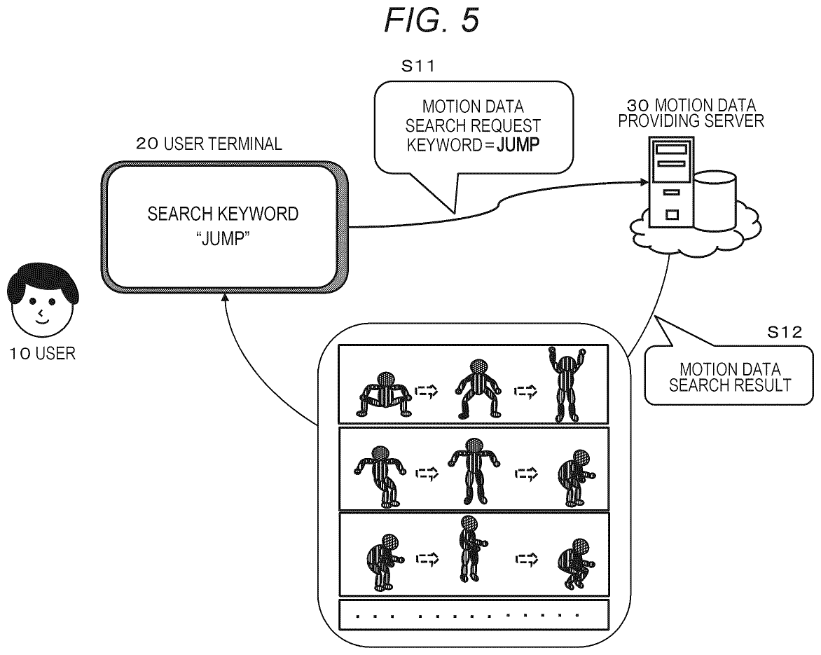

In this processing example, as search request processing from the user terminal 20 to the motion data providing server 30, for example, a search request using a search keyword can be made as illustrated in FIG. 5.

The motion data providing server 30 can execute search processing for motion data indicating the jump action according to the search keyword=jump received from the user terminal 20.

However, the case where the search processing using such a keyword can be executed is limited to a case where the action can be defined by a specific word.

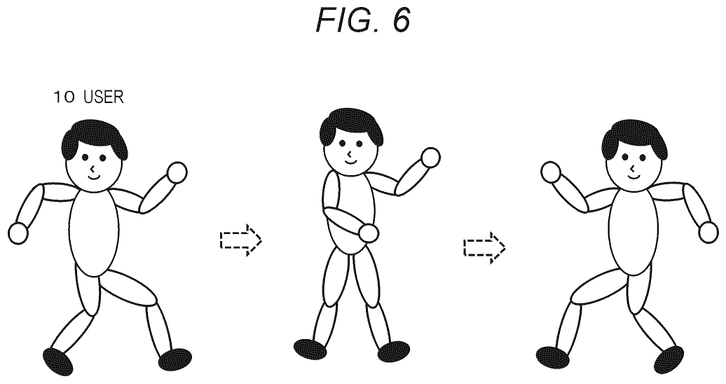

For example, in a case of attempting to search for motion data corresponding to the action as illustrated in FIG. 6, the user terminal 20 can perform the search by transmitting, for example, “keyword=dance” as a search request keyword to the motion data providing server 30.

However, when the motion data providing server 30 performs data search on the basis of “keyword=dance”, a large number of pieces of motion data related to various dances are output as a search result. As a result, the motion data providing server 30 transmits a large number of search results to the user terminal 20, and the user 10 has to sequentially check the large number of pieces of motion data, which causes a problem that it is difficult to efficiently find desired motion data.

Furthermore, even in a case where various keywords are registered in association with each motion, a search cannot be performed with the keywords in some cases.

The processing of the present disclosure solves such a problem and is capable of efficiently acquiring motion data desired by the user from a large number of pieces of various motion data held by the server.

Specifically, by using motion data input via a sensor attached to the body of the user as a search key, it is possible to provide an intuitive search service capable of detecting similarity of a part of a large number of various series of motion data held by the server with high accuracy and efficiently acquiring motion data desired by the user.

Hereinafter, a specific example of the processing of the present disclosure will be described.

### 2. (First Embodiment) Embodiment Enabling Identification of Search Motion Information Area Using Specific Pose

Next, as a first embodiment of the present disclosure, an embodiment enabling identification of a search motion information area using a specific pose will be described.

As described with reference to FIG. 6, the keyword search is insufficient to search for motion data corresponding to a desired action of the user.

For example, it is difficult to search for motion data using keywords not only in the case of a dance action as illustrated in FIG. 6 but also in the case of an action with a complicated motion or the like.

The processing of the present disclosure solves such a problem and enables highly accurate and efficient search for motion data corresponding to a user's desired action.

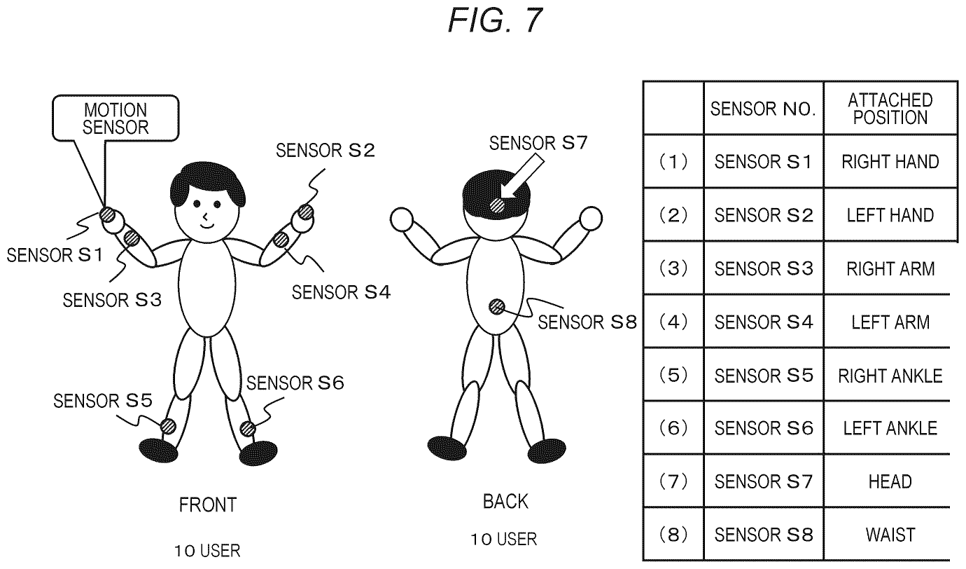

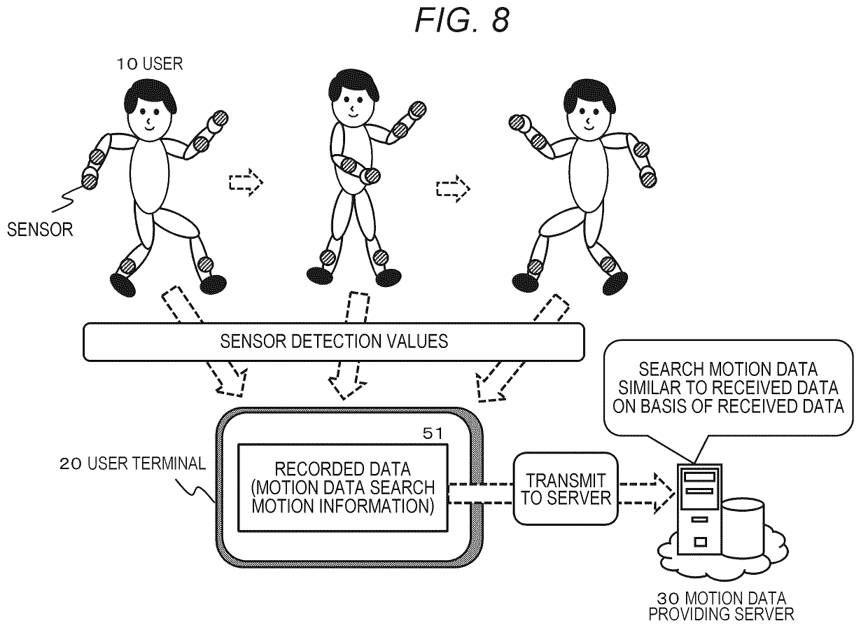

Details of the processing of the present disclosure will be described with reference to FIG. 7 and subsequent drawings.

In the processing of the present disclosure, as illustrated in FIG. 7, a plurality of sensors is worn on the body of the user 10, and motion information of the user obtained on the basis of a sensor detection value is transmitted to the motion data providing server 30.

The motion data providing server 30 searches for a plurality of pieces of motion data similar to the motion information of the user, and transmits the motion data to the user terminal 20.

The user 10 displays and reproduces the plurality of motion data received from the motion data providing server 30 on the display unit of the user terminal 20, and selects and purchases motion data closest to the motion desired by the user 10.

By performing such processing, it is possible to efficiently acquire motion data corresponding to various actions for which keyword search is difficult.

FIG. 7 illustrates a wearing example of sensors for acquiring motion information of the user 10 to be transmitted to the motion data providing server 30.

Note that the sensor worn by the user 10 is a motion sensor, and for example, an acceleration sensor or an inertial measurement unit (IMU) is used.

The IMU is a motion sensor capable of simultaneously measuring accelerations in xyz three-axis directions, angular velocities around xyz three axes, and the like.

Next, a wearing example of sensors (motion sensors) on the user 10 will be described with reference to FIG. 7.

In the example illustrated in FIG. 7, the user 10 has the following seven motion sensors worn on respective parts of the body:
(1) Right hand motion sensor S1;
(2) Left hand motion sensor S2;
(3) Right arm motion sensor S3;
(4) Left arm motion sensor S4;
(5) Right ankle motion sensor S5;
(6) Left ankle motion sensor S6;
(7) Head motion sensor S7; and
(8) Waist motion sensor S8.

These eight motion sensors individually detect motions of these eight parts of the right hand, left hand, right arm, left arm, right foot, left foot, head, and waist of the user.

As illustrated in FIG. 7, the motion sensors (for example, IMUs) worn on these eight parts of the right hand, left hand, right arm, left arm, right foot, left foot, head, and waist, and the waist of the user output accelerations in the three axis directions and the angular velocities around three axes of these eight parts of the right hand, left hand, right arm, left arm, right foot, left foot, head, and waist, and the waist as sensor detection values.

Note that although the wearing example of the sensors illustrated in FIG. 7 is an example of wearing the sensors on the eight positions of the user's body, this is an example, and various modes of wearing sensors are available, such as a configuration of wearing the sensors on only both hands, a configuration of wearing the sensors on only both hands and both feet, and a configuration of wearing more sensors on respective parts of the body.

Detection values of the sensors worn by the user 10 are first transmitted to the user terminal 20 such as a smartphone or a PC of the user 10. The detection value transmission processing is executed by near field communication such as Bluetooth (registered trademark).

The user terminal 20 that has received the sensor detection values transmits the received sensor detection values or the motion information of the user 10 analyzed on the basis of the sensor detection values to the motion data providing server 30.

A communication process example of the sensor detection value will be described with reference to FIG. 8.

As illustrated in FIG. 8, the user 10 wearing the sensors executes an action corresponding to motion data desired by the user.

Each of the sensors worn on the respective parts of the user 10 transmits time-series sensor detection values associated with the user action of the user 10 to the user terminal 20.

The user terminal 20 records the received sensor detection values or the user motion information generated on the basis of the sensor detection values as “recorded data (motion data search motion information) 51”, and transmits recorded data 51 to the motion data providing server 30.

The motion data providing server 30 executes data search processing of selecting motion data similar to the “recorded data (motion data search motion information) 51” received from the user terminal 20 from a large number of pieces of motion data stored in the storage unit (database), and transmits a search result to the user terminal 20.

However, as a problem of this process, there is a problem that the “recorded data (motion data search motion information) 51” transmitted from the user terminal 20 to the motion data providing server 30 includes data unnecessary for the motion data search processing.

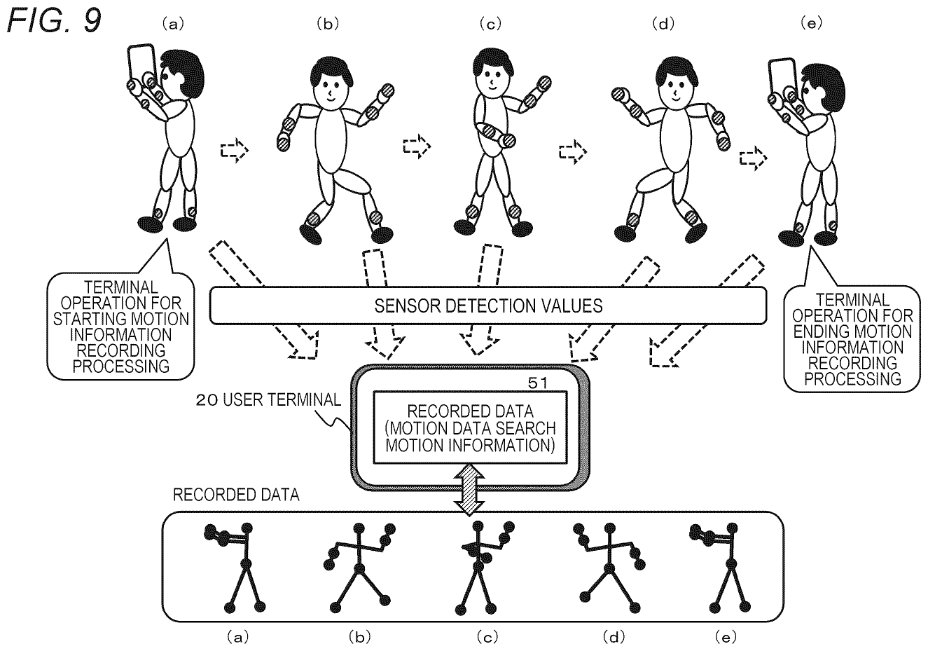

This problem will be described with reference to FIG. 9 and subsequent drawings.

In the top part of FIG. 9, the actions of the user 10 are illustrated in time series ((a) to (e)).

(a) illustrates an operating state of the user terminal 20 for starting the motion information recording processing. Specifically, for example, it is a state in which an application for recording a user action is activated and a user operation for starting processing of receiving sensor detection values is performed. After this user operation, the user terminal 20 starts processing of receiving and recording detection values of the sensors worn on the respective parts of the user 10, and processing of generating and recording user motion information based on the sensor detection values.

After the terminal operation illustrated in (a), the user 10 performs actions of (b) to (d) illustrated in FIG. 9 as a motion for motion data search.

After the end of the actions (b) to (d), the user 10 finally executes the process illustrated in (e). (e) illustrates an operating state of the user terminal 20 for the user 10 to end the motion information recording processing. Specifically, for example, it is a state in which a user operation is performed to end the processing of receiving the sensor detection values by operating the UI of the application that records the user action. When this user operation is performed, the user terminal 20 stops the processing of receiving the detection values of the sensors worn on the respective parts of the user 10.

In a case where the user 10 performs a series of actions (a) to (e) illustrated in FIG. 9, pieces of recorded data (a) to (e) illustrated in the lower part of FIG. 9 are recorded as “recorded data (motion data search motion information) 51” in the user terminal 20.

That is, the “recorded data (motion data search motion information) 51” also includes respective actions which are the user terminal operation processing actions (a) and (e) of the user 10.

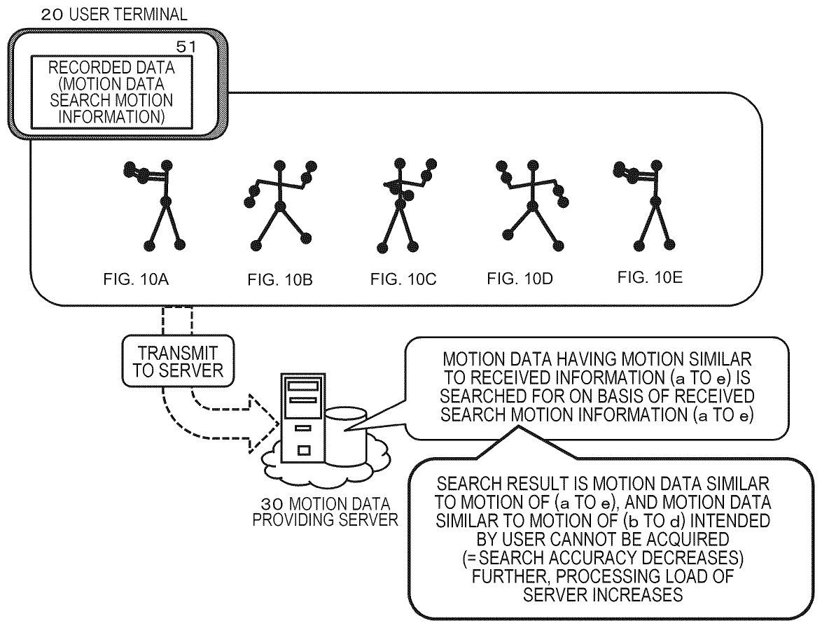

As illustrated in FIG. 10, the user terminal 20 transmits the recorded data (a) to (e), that is, the recorded data 51 including a series of user actions (a) to (e) including user terminal operation processing actions (a) and (e) of the user 10, to the motion data providing server 30 as “motion data search motion information”.

The motion data providing server 30 performs processing of searching for motion data similar to the motions (a) to (e) of the user on the basis of the “recorded data (motion data search motion information) 51” including the user terminal operation processing actions (a) and (e) of the user 10 received from the user terminal 20.

As a result, the search result generated by the motion data providing server 30 is motion data similar to the motions of ((a) to (e)) including the user terminal operation processing actions (a) and (e) of the user 10. That is, a search result different from the motion data corresponding to the actions ((b) to (d)) intended by the user is generated.

The search result finally transmitted from the motion data providing server 30 to the user terminal 20 is data different from the motion data corresponding to the actions ((b) to (d)) intended by the user, and the user cannot acquire the target motion data.

That is, motion data similar to the actions ((b) to (d)) that the user intends to acquire cannot be acquired. Furthermore, there is also a problem that the processing load of the server increases.

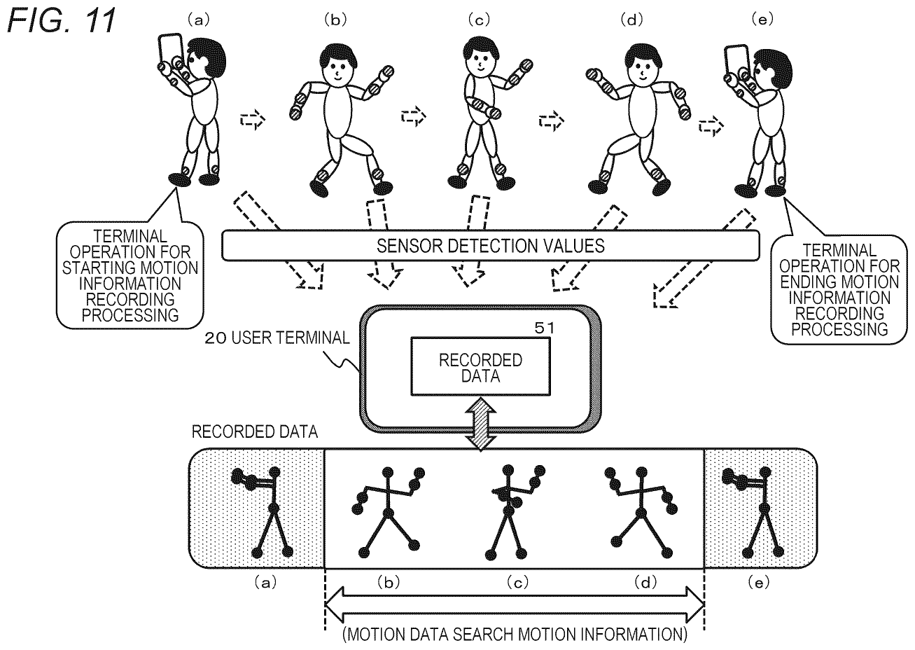

A processing example for solving these problems will be described with reference to FIG. 11 and subsequent drawings.

The upper part of FIG. 11 illustrates an action sequence ((a) to (e)) including a terminal operation of the user 10 as described above with reference to FIG. 9.

The user terminal 20 records the recorded data illustrated in the lower part of FIG. 11, that is, the actions ((a) to (e)) of the user 10 including the user terminal operation processing actions (a) and (e) of the user 10.

However, among the recorded data, data to be applied to search processing for motion data is the user actions of (b) to (d).

That is, if the data transmitted from the user terminal 20 to the motion data providing server 30 is data including only the user actions of (b) to (d), the motion data providing server 30 can perform search processing for motion data similar to the data including only the user actions of (b) to (d).

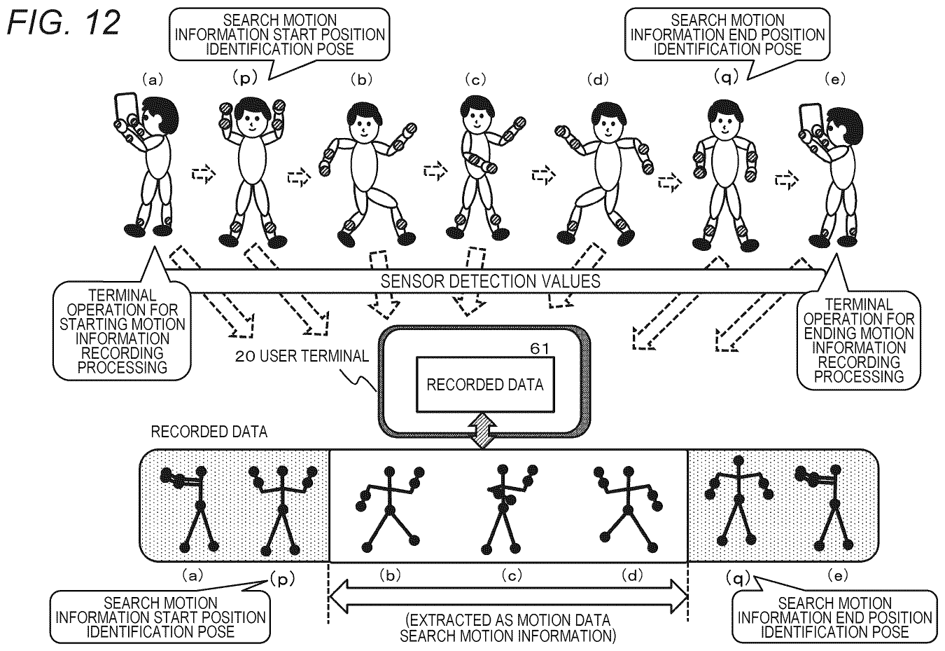

A specific example for implementing such processing, that is, the embodiment (first embodiment) in which the search motion information area can be identified using a specific pose will be described with reference to FIG. 12 and subsequent drawings.

The upper part of FIG. 12 illustrates an action example of the user 10. The user actions illustrated in FIG. 12 have a configuration in which the following two poses are added among the actions (a) to (e) described with reference to FIGS. 9 and 11.

The pose of (p) between (a) and (b)=search motion information start position identification pose, and

The pose of (q) between (d) and (e)=search motion information end position identification pose,

Note that the actions of (a) to (e) are similar to the actions of (a) to (e) described with reference to FIGS. 9 and 11, and respectively correspond to the following actions.
(a) Operation of user terminal 20 for starting motion information recording processing
(b) to (d) Motion data search action
(e) Operation of user terminal 20 for ending motion information recording processing

That is, the user's movement (a)→(p)→(b)→(c)→(d)→(q)→(e) illustrated in FIG. 12 is a sequence in which the poses (p) and (q) are added between the actions (a) to (e) described with reference to FIG. 9 and FIG. 11.

Specifically, the sequence is obtained by adding the following two poses.

Note that these two poses, that is,
the pose of (p)=search motion information start position identification pose, and
the pose of (q)=search motion information end position identification pose,
are registered in the user terminal 20 in advance.

For example, the poses are stored in the storage unit of the user terminal 20 as registration data corresponding to the motion data search application.

Note that, as the forms of these poses, a default pose predefined by the motion data search application may be used, or a pose uniquely determined by the user may be registered and used.

As described above, in the action sequence illustrated in FIG. 12, the pose (p), that is, “(p) search motion information start position identification pose” is added between the action (a) in which the user 10 performs the motion information recording start operation on the user terminal 20 and the action (b) at the start time of the motion data search action.

Furthermore, a pose (q), that is, “(q) search motion information end position identification pose” is added between the action (d) at the end of the motion data search action and the action (e) in which the user 10 performs the motion information recording end operation on the user terminal 20.

As a result, the recorded data recorded in the user terminal 20 becomes recorded data 61 as illustrated in the lower part of FIG. 12. That is, sequence data of the following actions and poses is obtained.
(a) Operation action of user terminal 20 for starting motion information recording processing
(p) Search motion information start position identification pose
(b) to (d) Motion data search action
(q) Search motion information end position identification pose
(e) Operation action of user terminal 20 for ending motion information recording processing

The user terminal 20 identifies, from the recorded data 61, that is, the sequence data indicating the respective action states of (a), (p), and (b) to (d), (q), and (e), pose positions of
(p) search motion information start position identification pose, and
(q) search motion information end position identification pose,
extracts data of a section interposed between these identified pose positions, that is, motion information areas of (b) to (d) illustrated in the lower part of FIG. 12, as motion data search motion information, and transmits the motion data search motion information to the motion data providing server 30.

That is, the data processing unit of the user terminal 20 detects, from the action sequence of the user 10, a pose matching poses of the following two poses registered in the storage unit of the user terminal 20, that is,
(p) search motion information start position identification pose and
(q) search motion information end position identification pose,
extracts the motion information areas of (b) to (d) in the section interposed between the detected poses (p) and (q) as the motion data search motion information, and transmits the motion data search motion information to the motion data providing server 30.

With this processing, the motion data providing server 30 can perform search processing for motion data similar to data including only the user actions of (b) to (d), and the user 10 can receive motion data similar to only “(b) to (d) motion data search motion information area” from the motion data providing server 30 as a search result.

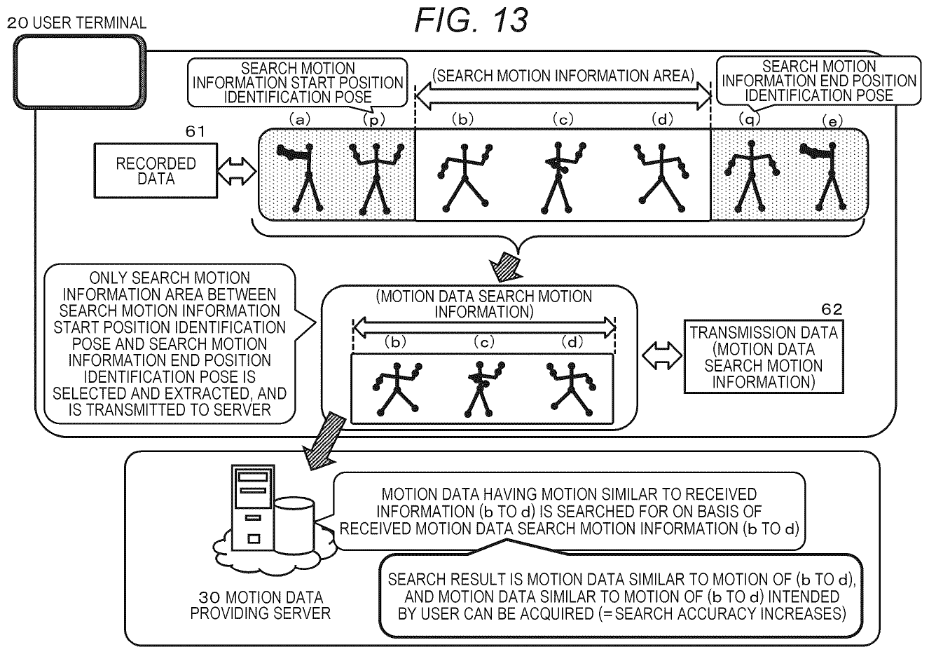

This processing will be described in detail with reference to FIG. 13.

In FIG. 13, processing of the user terminal 20 is illustrated in the upper part, and processing of the motion data providing server 30 is illustrated in the lower part.

First, processing of the user terminal 20 illustrated in the upper part will be described.

The user terminal 20 records, in the storage unit, the recorded data 61 corresponding to the action sequence of the user actions ((a), (p), and (b) to (d), (q), and (e)) described above with reference to FIG. 12. The recorded data 61 illustrated in FIG. 13 is sequence data of the following actions.
(a) Operation action of user terminal 20 for starting motion information recording processing
(p) Search motion information start position identification pose
(b) to (d) Motion data search action
(q) Search motion information end position identification pose
(e) Operation action of user terminal 20 for ending motion information recording processing

First, the user terminal 20 identifies
(p) search motion information start position identification pose and (q) search motion information end position identification pose from the recorded data 61.

That is, the data processing unit of the user terminal 20 detects, from the action sequence of the user 10, a pose matching the following two poses registered in the storage unit of the user terminal 20, that is,
(p) search motion information start position identification pose, and
(q) search motion information end position identification pose.

Next, the user terminal 20 extracts data in a section interposed between the detected pose positions (p) and (q), that is, the areas of (b) to (d) illustrated in FIG. 13, as motion data search motion information, and transmits the extracted data to the motion data providing server 30 as “transmission data (motion data search motion information) 62”.

The lower part of FIG. 13 illustrates processing of the motion data providing server 30.

The motion data providing server 30 receives the transmission data 62 from the user terminal 20.

The received data is the data in the section interposed between the pose positions (p) and (q), that is, the data in the section of (b) to (d) illustrated in FIG. 13.

The motion data providing server 30 executes search processing using the data in the section (b) to (d) as motion data search motion information.

As a result, motion data similar only to the data in the section (b) to (d) is retrieved, and this search result is transmitted to the user terminal 20.

Through these processes, the motion data providing server 30 can generate a search result of motion data similar to data including only the “(b) to (d) motion data search motion information area” and transmit the search result to the user terminal 20.

The user 10 can receive motion data similar to only the “(b) to (d) motion data search motion information area” from the motion data providing server 30.

That is, motion data desired by the user can be acquired with high accuracy and efficiency.

The processing described with reference to FIG. 13 is a processing example in which the user terminal 20 generates transmission data 62 obtained by extracting data including only the “(b) to (d) motion data search motion information area” from the recorded data 61 recorded by the user terminal 20, that is, the recorded data 61 corresponding to the action sequence of the user actions ((a), (p), and (b) to (d), (q), and (e)), and transmits the transmission data to the motion data providing server 30.

On the other hand, the configuration may be such that the recorded data 61 recorded by the user terminal 20, that is, the recorded data 61 corresponding to the action sequence of the user actions ((a), (p), and (b) to (d), (q), and (e)) is transmitted as it is to the motion data providing server 30, and the motion data providing server 30 side extracts data including only “(b) to (d) motion data search motion information area” and executes search processing based on the extracted data.

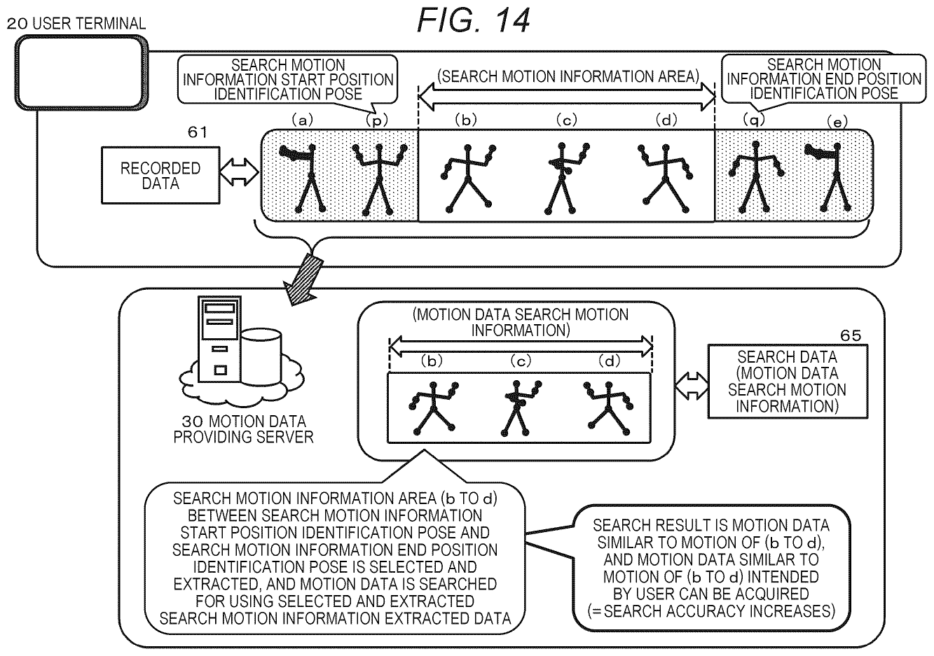

A processing sequence in a case of performing this processing will be described with reference to FIG. 14.

Similarly to FIG. 13, FIG. 14 also illustrates processing of the user terminal 20 in the upper part and processing of the motion data providing server 30 in the lower part.

First, processing of the user terminal 20 illustrated in the upper part will be described.

The user terminal 20 records, in the storage unit, the recorded data 61 corresponding to the action sequence of the user actions ((a), (p), and (b) to (d), (q), and (e)) described above with reference to FIG. 12. The recorded data 61 illustrated in FIG. 14 is sequence data of the following actions.
(a) Operation action of user terminal 20 for starting motion information recording processing
(p) Search motion information start position identification pose
(b) to (d) Motion data search action
(q) Search motion information end position identification pose
(e) Operation action of user terminal 20 for ending motion information recording processing

The user terminal 20 transmits the recorded data 61 as it is to the motion data providing server 30.

The lower part of FIG. 14 illustrates processing of the motion data providing server 30.

The motion data providing server 30 receives the recorded data 61 as it is from the user terminal 20.

From the recorded data 61 received from the user terminal 20, that is, the recorded data 61 including each action sequence of (a), (p), and (b) to (d), (q), and (e), the motion data providing server 30 detects pose positions of:
(p) search motion information start position identification pose; and
(q) search motion information end position identification pose.

Note that these two poses, that is,
the pose of (p)=search motion information start position identification pose, and
the pose of (q)=search motion information end position identification pose,
are registered in the motion data providing server 30 in advance.

As described above, for these poses, a default pose predefined by the motion data search application may be used, or a pose uniquely determined by the user may be registered and used.

However, in a case where the user uses a pose independently determined by the user, it is necessary to perform processing of transmitting and registering the pose from the user terminal 20 to the motion data providing server 30 in advance.

Next, the motion data providing server 30 extracts data in a section interposed between the detected pose positions (p) and (q), that is, areas of (b) to (d) illustrated in FIG. 14 as motion data search motion information, and sets the extracted data as “search data (motion data search motion information) 65”.

The “search data (motion data search motion information) 65” is data in a section interposed between the pose positions (p) and (q), that is, data in the section of (b) to (d) illustrated in FIG. 14.

The motion data providing server 30 executes search processing using the data in the sections (b) to (d) as the search data (motion data search motion information) 65.

As a result, motion data similar only to the data in the sections (b) to (d) is retrieved.

The motion data providing server 30 transmits this search result to the user terminal 20.

Through these processes, the motion data providing server 30 can generate a search result of motion data similar to data including only the “(b) to (d) motion data search motion information area” and transmit the search result to the user terminal 20.

The user 10 can receive motion data similar to only the “(b) to (d) motion data search motion information area” from the motion data providing server 30.

That is, motion data desired by the user can be acquired with high accuracy and efficiency.

In this manner, by executing any one of the processes described with reference to FIGS. 13 and 14, the data in the section interposed between the pose positions (p) and (q), that is, the “motion data search motion information” in the areas (b) to (d) is extracted from recorded data including a terminal operating action of the user, and the motion data search processing based on the extracted data is executed.

As a result, the user 10 can accurately and efficiently acquire motion data desired by the user from among a large number of pieces of motion data held by the motion data providing server 30.

### 3. (Second Embodiment) Embodiment Enabling Identification of Search Motion Information Area Using Set of Poses Including Plurality of Poses

Next, as a second embodiment, an embodiment enabling identification of a search motion information area using a pose set including a plurality of poses will be described.

In the first embodiment described with reference to FIGS. 12 to 14,
the processing of detecting the two pose positions of:
the pose of (p)=search motion information start position identification pose, and
the pose of (q)=search motion information end position identification pose, and
extracting the data area of the “motion data search motion information” has been executed.

These poses (p) and (q) are registered in advance in the storage unit of the user terminal 20 or the motion data providing server 30, and the user terminal 20 or the motion data providing server 30 performs processing of detecting a user action matching or similar to a registered pose from the user action sequence and extracting the data area of the “motion data search motion information”.

However, the action of the “motion data search motion information” area during the action sequence by the user 10 is diverse, and there is a possibility that a pose similar to the poses (p) and (q) registered in advance appears also in the “motion data search motion information” area.

In such a case, the user terminal 20 or the motion data providing server 30 may erroneously recognize the action matching the registered poses (p) and (q) appearing in the “motion data search motion information” area as the “search motion information start position identification pose” or the “search motion information end position identification pose”.

When such erroneous recognition occurs, the user terminal 20 or the motion data providing server 30 cannot correctly extract the “motion data search motion information” area, and as a result, a motion data search error occurs.

The (second embodiment) described below is an embodiment for solving this problem.

Specifically, this is an embodiment enabling identification of a search motion information area using a set of a plurality of poses.

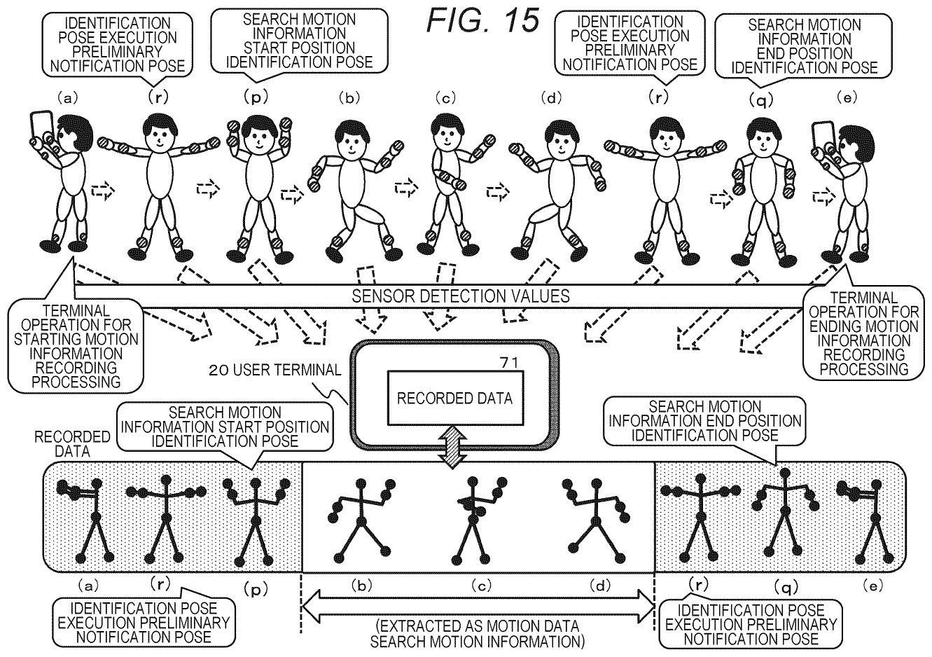

This embodiment will be described with reference to FIG. 15 and subsequent drawings.

The upper part of FIG. 15 illustrates an operation example of the user 10. The user action illustrated in FIG. 15 has a configuration in which a pose set including two poses ((r) and (p)) is added between the actions (a) and (b) and a pose set including two poses ((r) and (q)) is added between the actions (d) and (e) in the action sequence of (a) to (e) described with reference to FIG. 9 and FIG. 11.

Namely, it is an action sequence in which the following two pose sets are added:
a pose set that is a combination of the following two poses ((r) and (p)),
the pose of (r)=identification pose execution preliminary notification pose and
the pose of (p)=search motion information start position identification pose, added between (a) and (b); and
a pose set that is a combination of the following two poses ((r) and (q)),
the pose of (r)=identification pose execution preliminary notification pose and
the pose of (q)=search motion information end position identification pose, added between (d) and (e).

Note that the actions of (a) to (e) are similar to the actions of (a) to (e) described with reference to FIGS. 9 and 11, and respectively correspond to the following actions.
(a) Operation of user terminal 20 for starting motion information recording processing
(b) to (d) Motion data search action
(e) Operation of user terminal 20 for ending motion information recording processing

Furthermore, the poses (p) and (q) are similar to the poses described with reference to FIGS. 12 to 14 in the first embodiment above, and are the following identification poses.

The pose of (p)=search motion information start position identification pose,

The pose of (q)=search motion information end position identification pose,

In the second embodiment, the pose of (r), that is, the pose of (r)=identification pose execution preliminary notification pose
is executed before the pose (p) and the pose (q).

That is, the user's motion (a)→(r)→(p)→(b)→(c)→(d)→(r)→(q)→(e) illustrated in FIG. 15 is a sequence in which one pose set including two poses (r) and (p) is added between the actions (a) and (b) in the action sequence of (a) to (e) described with reference to FIG. 9 and FIG. 11, and one pose set including two poses (r) and (q) is further added between the actions (d) and (e).

Note that these three poses, that is,
the pose of (p)=search motion information start position identification pose,
the pose of (q)=search motion information end position identification pose, and
the pose of (r)=identification pose execution preliminary notification pose
are registered in the user terminal 20 in advance.

For example, the poses are stored in the storage unit of the user terminal 20 as registration data corresponding to the motion data search application.

Note that, as the forms of these poses, a default pose predefined by the motion data search application may be used, or a pose uniquely determined by the user may be registered and used.

As described above, in the action sequence illustrated in FIG. 15, a pose set of the pose (r) and the pose (p), that is, a pose set including the following two poses:
the pose (r)=identification pose execution preliminary notification pose; and
the pose (p)=search motion information start position identification pose,
are added between the action (a) in which the user 10 performs the motion information recording start operation on the user terminal 20 and the action (b) at the start time of the motion data search action.

Moreover, a pose set of the pose (r) and the pose (q), that is, a pose set including the following two poses:
the pose (r)=identification pose execution preliminary notification pose; and
the pose (p)=search motion information end position identification pose,
are added between the action (d) at the end of the motion data search action and the action (e) in which the user 10 is performing the motion information recording end operation on the user terminal 20.

As a result, the recorded data recorded in the user terminal 20 becomes recorded data 61 as illustrated in the lower part of FIG. 15. That is, sequence data of the following actions and poses is obtained.
(a) Operation action of user terminal 20 for starting motion information recording processing
(r) Identification pose execution preliminary notification pose
(p) Search motion information start position identification pose
(b) to (d) Motion data search action
(r) Identification pose execution preliminary notification pose
(q) Search motion information end position identification pose
(e) Operation action of user terminal 20 for ending motion information recording processing

The user terminal 20 identifies, from the recorded data 61, that is, the sequence data indicating each of the action states of (a), (r) (p), and (b) to (d), (r), (q), and (e), pose set positions of two of:
a pose set of two poses of
(r) identification pose execution preliminary notification pose, and
(p) search motion information start position identification pose; and
a pose set of two poses of
(r) identification pose execution preliminary notification pose, and
(q) search motion information end position identification pose,
extracts data in a section interposed between these identified pose set positions, that is, the motion information areas of (b) to (d) illustrated in the lower part of FIG. 15 as motion data search motion information, and transmits the motion data search motion information to the motion data providing server 30.

That is, the data processing unit of the user terminal 20 performs the following three poses registered in the storage unit of the user terminal 20, that is,
(p) search motion information start position identification pose,
(q) search motion information end position identification pose, and
(r) identification pose execution preliminary notification pose.

The following processing is executed with reference to these registered poses.

From the action sequence of the user 10, detection processing of the following two pose sets is performed:
a pose set of two poses of
(r) identification pose execution preliminary notification pose, and
(p) search motion information start position identification pose; and
a pose set of two poses of
(r) identification pose execution preliminary notification pose, and
(q) search motion information end position identification pose.

Moreover, the motion information areas of (b) to (d) in a section interposed between the detected pose sets (r) and (p) and (r) and (q) are extracted as motion data search motion information, and transmitted to the motion data providing server 30.

With this processing, the motion data providing server 30 can perform search processing for motion data similar to data including only the user actions of (b) to (d), and the user 10 can receive motion data similar to only “(b) to (d) motion data search motion information area” from the motion data providing server 30 as a search result.

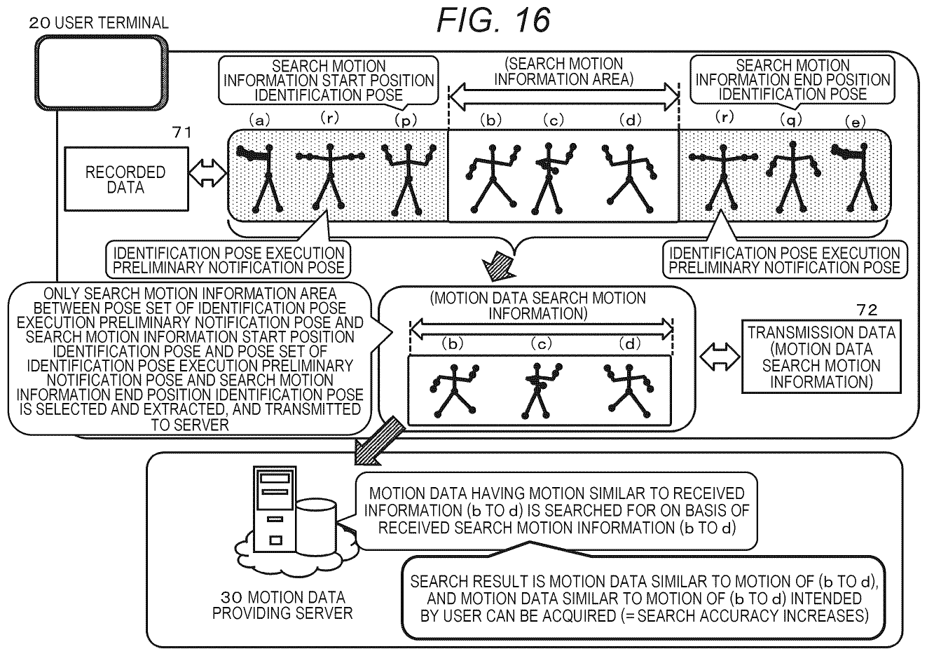

This processing will be described with reference to FIG. 16.

In FIG. 16, processing of the user terminal 20 is illustrated in the upper part, and processing of the motion data providing server 30 is illustrated in the lower part.

First, the processing of the user terminal 20 illustrated in the upper part will be described.

The user terminal 20 records, in the storage unit, recorded data 71 corresponding to the action sequence of the user actions ((a), (r), (p), and (b) to (d), (r), (q), and (e)) described above with reference to FIG. 15. The recorded data 71 illustrated in FIG. 16 is sequence data of the following actions.
(a) Operation action of user terminal 20 for starting motion information recording processing
(r) Identification pose execution preliminary notification pose
(p) Search motion information start position identification pose
(b) to (d) Motion data search action
(r) Identification pose execution preliminary notification pose
(q) Search motion information end position identification pose
(e) Operation action of user terminal 20 for ending motion information recording processing

First, the user terminal 20 detects, from the recorded data 71, two pose set positions of:
a first pose set including
(r) identification pose execution preliminary notification pose, and
(p) search motion information start position identification pose; and
a second pose set including
(r) identification pose execution preliminary notification pose, and
(q) search motion information end position identification pose.

That is, the data processing unit of the user terminal 20 calculates, from the action sequence of the user 10, the following three poses registered in the storage unit of the user terminal 20, that is,
(p) search motion information start position identification pose,
(q) search motion information end position identification pose, and
(r) identification pose execution preliminary notification pose.

The following processing is executed with reference to these registered poses.

From the action sequence of the user 10, detection processing of the following two pose sets is performed:
a first pose set of poses of
(r) identification pose execution preliminary notification pose, and
(p) search motion information start position identification pose; and
a second pose set of poses of
(r) identification pose execution preliminary notification pose, and
(q) search motion information end position identification pose.

Next, the user terminal 20 extracts data of a section interposed between the detected two pose sets (r) and (p) and (r) and (q), that is, the areas of (b) to (d) illustrated in FIG. 16 as motion data search motion information, and transmits the extracted data to the motion data providing server 30 as “transmission data (motion data search motion information) 72”.

The lower part of FIG. 16 illustrates processing of the motion data providing server 30.

The motion data providing server 30 receives the transmission data 62 from the user terminal 20.

This received data is data in a section interposed between the first pose set (r) and (p) and the second pose set (r) and (q), that is, data in the section of (b) to (d) illustrated in FIG. 16.

The motion data providing server 30 executes search processing using the data in the section (b) to (d) as motion data search motion information.

As a result, motion data similar only to the data in the section (b) to (d) is retrieved, and this search result is transmitted to the user terminal 20.

Through these processes, the motion data providing server 30 can generate a search result of motion data similar to data including only the “(b) to (d) motion data search motion information area” and transmit the search result to the user terminal 20.

The user 10 can receive motion data similar to only the “(b) to (d) motion data search motion information area” from the motion data providing server 30.

That is, motion data desired by the user can be acquired with high accuracy and efficiency.

In this processing example, in order to identify “(b) to (d) motion data search motion information area”, processing of detecting the following two pose sets is executed:
a first pose set of poses of
(r) identification pose execution preliminary notification pose, and
(p) search motion information start position identification pose; and
a second pose set of poses of
(r) identification pose execution preliminary notification pose, and
(q) search motion information end position identification pose.

In the first embodiment described above, single poses of these
(p) search motion information start position identification pose, and
(q) search motion information end position identification pose,
are used as poses for identifying the “(b) to (d) motion data search motion information area”.

Such a single pose may appear in the “(b) to (d) motion data search motion information area”, and if it appears, correct processing cannot be performed.

However, in the second embodiment, the first pose set (r) and (p) and the second pose set (r) and (q) including two different poses are used as pose sets for identifying the “(b) to (d) motion data search motion information area”.

Such a pose set including two poses is extremely unlikely to appear in the “(b) to (d) motion data search motion information area”, and highly accurate and highly reliable processing can be performed.

The processing described with reference to FIG. 16 is a processing example in which the user terminal 20 generates transmission data 62 obtained by extracting data including only the “(b) to (d) motion data search motion information area” from the recorded data 71 recorded by the user terminal 20, that is, the recorded data 61 corresponding to the action sequence of the user actions ((a), (r), (p), and (b) to (d), (r), (q), and (e)), and transmits the transmission data to the motion data providing server 30.

On the other hand, the configuration may be such that the recorded data 61 recorded by the user terminal 20, that is, the recorded data 71 corresponding to the action sequence of the user actions ((a), (r), (p), and (b) to (d), (r), (q), and (e)) is transmitted as it is to the motion data providing server 30, and the motion data providing server 30 side extracts data including only the “(b) to (d) motion data search motion information area” and executes search processing based on the extracted data.

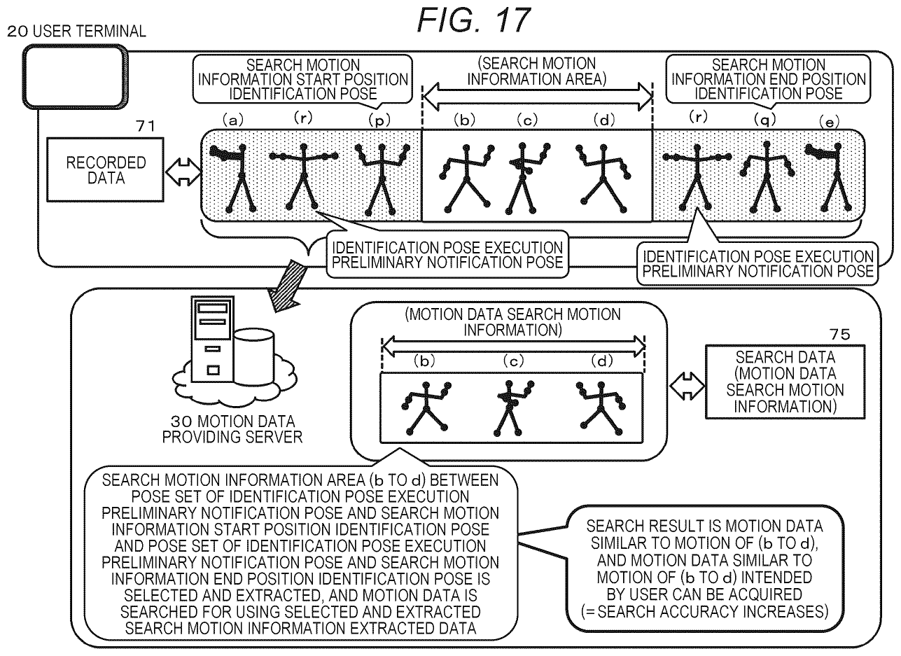

A processing sequence in a case of performing this processing will be described with reference to FIG. 17.

Similarly to FIG. 16, FIG. 17 also illustrates processing of the user terminal 20 in the upper part and processing of the motion data providing server 30 in the lower part.

First, processing of the user terminal 20 illustrated in the upper part will be described.

The user terminal 20 records, in the storage unit, recorded data 71 corresponding to the action sequence of the user actions ((a), (r), (p), and (b) to (d), (r), (q), and (e)) described above with reference to FIG. 15. The recorded data 71 illustrated in FIG. 17 is sequence data of the following actions.
(a) Operation action of user terminal 20 for starting motion information recording processing
(r) Identification pose execution preliminary notification pose
(p) Search motion information start position identification pose
(b) to (d) Motion data search action
(r) Identification pose execution preliminary notification pose
(q) Search motion information end position identification pose
(e) Operation action of user terminal 20 for ending motion information recording processing

The user terminal 20 transmits the recorded data 71 as it is to the motion data providing server 30.

The lower part of FIG. 17 illustrates processing of the motion data providing server 30.

The motion data providing server 30 receives the recorded data 71 as it is from the user terminal 20.

The motion data providing server 30 detects, from the recorded data 71 received from the user terminal 20, that is, the recorded data 61 including the respective action sequences of (a), (r), (p), and (b) to (d), (r), (q), and (e), two pose set positions of:
a first pose set including
(r) identification pose execution preliminary notification pose, and
(p) search motion information start position identification pose; and
a second pose set including
(r) identification pose execution preliminary notification pose, and
(q) search motion information end position identification pose.

Note that the following three poses, that is,
the pose of (p)=search motion information start position identification pose;
the pose of (q)=search motion information end position identification pose, and
(r) identification pose execution preliminary notification pose
are registered in the motion data providing server 30 in advance.

As described above, for these poses, a default pose predefined by the motion data search application may be used, or a pose uniquely determined by the user may be registered and used.

However, in a case where the user uses a pose independently determined by the user, it is necessary to perform processing of transmitting and registering the pose from the user terminal 20 to the motion data providing server 30 in advance.

Next, the motion data providing server 30 extracts data of a section interposed between the detected two pose sets (r) and (p) and (r) and (q), that is, the areas of (b) to (d) illustrated in FIG. 17 as motion data search motion information, and sets the extracted data as “search data (motion data search motion information) 75”.

The “search data (motion data search motion information) 75” is data in a section interposed between the first pose set positions (r) and (p) and the second pose set positions (r) and (q), that is, data in the section of (b) to (d) illustrated in FIG. 17.

The motion data providing server 30 executes search processing using the data in the sections (b) to (d) as the search data (motion data search motion information) 65.

As a result, motion data similar only to the data in the sections (b) to (d) is retrieved.

The motion data providing server 30 transmits this search result to the user terminal 20.

Through these processes, the motion data providing server 30 can generate a search result of motion data similar to data including only the “(b) to (d) motion data search motion information area” and transmit the search result to the user terminal 20.

The user 10 can receive motion data similar to only the “(b) to (d) motion data search motion information area” from the motion data providing server 30.

That is, motion data desired by the user can be acquired with high accuracy and efficiency.

In this manner, by executing any one of the processes described with reference to FIGS. 16 and 17, the data in the section interposed between the first pose set (r) and (p) and the second pose set (r) and (q), that is, the “motion data search motion information” in the areas (b) to (d) is extracted from recorded data including a terminal operating action of the user, and the motion data search processing based on the extracted data is executed.

As a result, the user 10 can accurately and efficiently acquire motion data desired by the user from among a large number of pieces of motion data held by the motion data providing server 30.

As described above, in the second embodiment, the first pose set (r) and (p) and the second pose set (r) and (q) including two different poses are used as pose sets for identifying the “(b) to (d) motion data search motion information area”.

Such a pose set including two poses is extremely unlikely to appear in the “(b) to (d) motion data search motion information area”, and highly accurate and highly reliable processing can be performed.

### 4. (Third Embodiment) Embodiment of Executing Motion Data Search Processing Based on Action of User Wearing VR Goggles

Next, as a third embodiment, an embodiment in which motion data search processing based on the action of the user wearing the VR goggles is executed will be described.

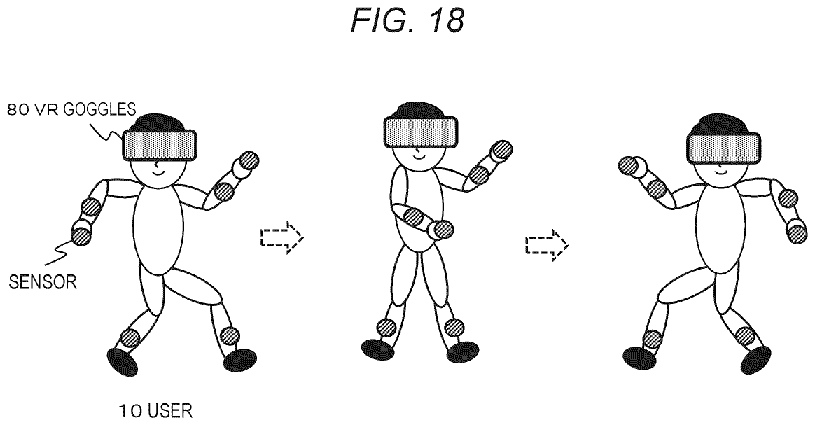

The third embodiment will be described with reference to FIG. 18 and subsequent drawings.

As illustrated in FIG. 18, for example, a user 10 wears VR goggles 80 for displaying a VR image (virtual reality image) and performs an action for motion data search.

Note that the user 10 wears the sensor described above with reference to FIG. 7 on each part of the body.

The user 10 wears the VR goggles 80, and performs an action for motion data search while observing three-dimensional virtual image content displayed on the VR goggles 80, for example.

Specifically, for example, while watching a character or a landscape in the content displayed on the VR goggles 80, an action is performed in accordance with these observation images.

Note that the configuration may be such that a motion sensor similar to the sensor worn on the body of the user 10 is also worn on the VR goggles 80, and a detection value from the sensor of the VR goggles is transmitted to the user terminal 20 such as a smartphone together with the detection value of the sensor worn on the body of the user.

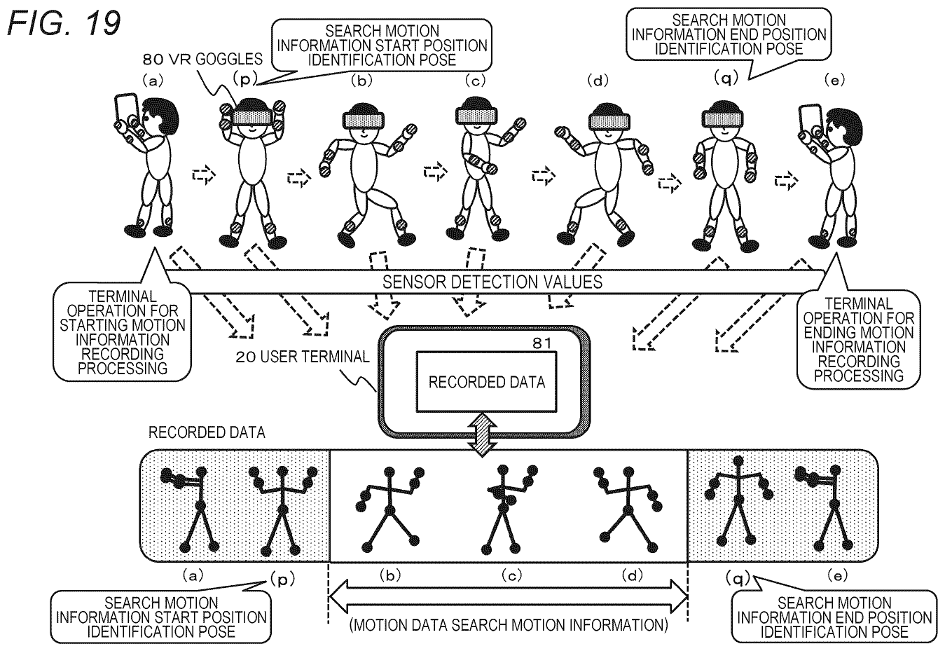

FIG. 19 is a diagram describing an example of search processing for motion data based on the action of the user 10 wearing the VR goggles 80, and is a diagram describing an execution example of processing similar to that of the first embodiment described above with reference to FIGS. 12 to 14.

The upper part of FIG. 19 illustrates an action example of the user 10 wearing the VR goggles 80. The action sequence of the user action illustrated in FIG. 19 is similar to the action sequence described with reference to FIG. 12 in the first embodiment above, and the recorded data recorded in the user terminal 20 is recorded data 81 as illustrated in the lower part of FIG. 19. That is, sequence data of the following actions and poses is obtained.
(a) Operation action of user terminal 20 for starting motion information recording processing
(p) Search motion information start position identification pose
(b) to (d) Motion data search action
(q) Search motion information end position identification pose
(e) Operation action of user terminal 20 for ending motion information recording processing

The user terminal 20 identifies, from the recorded data 81, that is, the sequence data indicating the respective action states of (a), (p), and (b) to (d), (q), and (e), pose positions of:
(p) search motion information start position identification pose; and
(q) search motion information end position identification pose,
extracts data of a section interposed between these identified pose positions, that is, motion information areas of (b) to (d) illustrated in the lower part of FIG. 19, as motion data search motion information, and transmits the motion data search motion information to the motion data providing server 30.

That is, the data processing unit of the user terminal 20 detects, from the action sequence of the user 10, a pose matching poses of the following two poses registered in the storage unit of the user terminal 20, that is,
(p) search motion information start position identification pose and
(q) search motion information end position identification pose,
extracts the motion information areas of (b) to (d) in the section interposed between the detected poses (p) and (q) as the motion data search motion information, and transmits the motion data search motion information to the motion data providing server 30.

With this processing, the motion data providing server 30 can perform search processing for motion data similar to data including only the user actions of (b) to (d), and the user 10 can receive motion data similar to only “(b) to (d) motion data search motion information area” from the motion data providing server 30 as a search result.

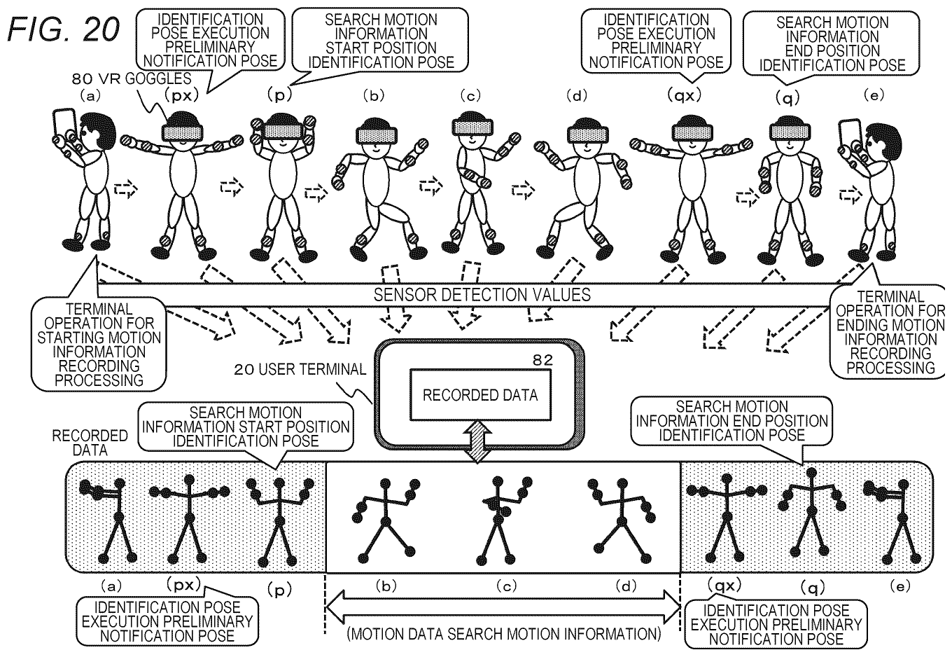

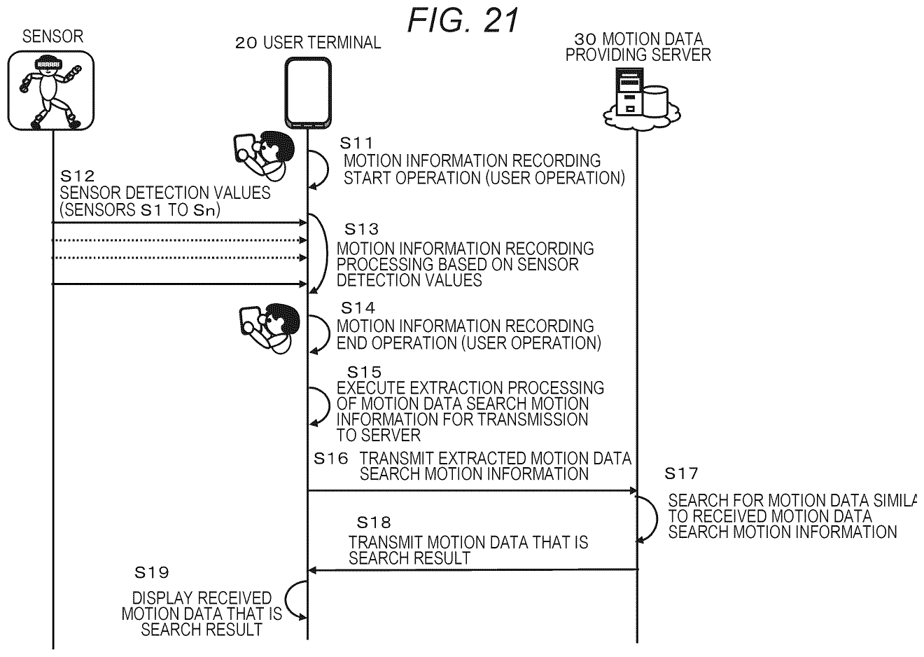

FIG. 20 is a diagram describing another processing example of motion data based on the action of the user 10 wearing the VR goggles 80, and is a diagram describing an execution example of processing similar to that of the second embodiment described above with reference to FIGS. 15 to 17.

The upper part of FIG. 20 illustrates an action example of the user 10 wearing the VR goggles 80. The action sequence of the user operation illustrated in FIG. 20 is similar to the action sequence described above with reference to FIG. 15 in the second embodiment, and the recorded data recorded in the user terminal 20 is recorded data 82 as illustrated in the lower part of FIG. 20. That is, sequence data of the following actions and poses is obtained.
(a) Operation action of user terminal 20 for starting motion information recording processing
(r) Identification pose execution preliminary notification pose
(p) Search motion information start position identification pose
(b) to (d) Motion data search action
(r) Identification pose execution preliminary notification pose
(q) Search motion information end position identification pose
(e) Operation action of user terminal 20 for ending motion information recording processing

The user terminal 20 identifies, from the recorded data 61, that is, the sequence data indicating each of the action states of (a), (r) (p), and (b) to (d), (r), (q), and (e), pose set positions of two of:
a pose set of two poses of
(r) identification pose execution preliminary notification pose, and
(p) search motion information start position identification pose; and
a pose set of two poses of
(r) identification pose execution preliminary notification pose, and
(q) search motion information end position identification pose,
extracts data in a section interposed between these identified pose set positions, that is, the motion information areas of (b) to (d) illustrated in the lower part of FIG. 20 as motion data search motion information, and transmits the motion data search motion information to the motion data providing server 30.

That is, the data processing unit of the user terminal 20 performs the following three poses registered in the storage unit of the user terminal 20, that is,
(p) search motion information start position identification pose,
(q) search motion information end position identification pose, and
(r) identification pose execution preliminary notification pose.

The following processing is executed with reference to these registered poses.

From the action sequence of the user 10, detection processing of the following two pose sets is performed:
a pose set of two poses of
(r) identification pose execution preliminary notification pose, and
(p) search motion information start position identification pose; and
a pose set of two poses of
(r) identification pose execution preliminary notification pose, and
(q) search motion information end position identification pose.

Moreover, the motion information areas of (b) to (d) in a section interposed between the detected pose sets (r) and (p) and (r) and (q) are extracted as motion data search motion information, and transmitted to the motion data providing server 30.

With this processing, the motion data providing server 30 can perform search processing for motion data similar to data including only the user actions of (b) to (d), and the user 10 can receive motion data similar to only “(b) to (d) motion data search motion information area” from the motion data providing server 30 as a search result.

### 5. Sequences of Processing Executed by Information Processing Device According to Present Disclosure

Next, sequences of processing executed by the information processing device according to the present disclosure will be described.

Note that the information processing device of the present disclosure includes the user terminal 20 and the motion data providing server 30.

First, a communication sequence among the sensors worn by the user 10, the user terminal 20, and the motion data providing server 30 will be described with reference to a sequence diagram illustrated in FIG. 21.

Note that the sequence diagram illustrated in FIG. 21 corresponds to the processing described above with reference to FIGS. 13 and 16, and is a sequence diagram in a case where the user terminal 20 executes processing of extracting the “motion data search motion information area” from user action recorded data including a terminal operating action by the user on the basis of identification pose, and executes processing of transmitting the extracted data to the motion data providing server 30.

Hereinafter, processing of each step of the sequence diagram illustrated in FIG. 21 will be sequentially described.

### Step S11

First, in step S11, the user 10 wearing the sensors executes a motion information recording start operation on the user terminal 20.

That is, an operation for causing the user terminal 20 to start processing of receiving and recording detection values of the worn sensors of the user 10 is executed.

### Steps S12 and S13

When the motion information recording start operation is executed on the user terminal 20 in step S11, the detection values of the sensors worn by the user 10 are sequentially transmitted to the user terminal 20 in steps S12 to S13, and recording processing is executed.

Note that, during this period, the user 10 executes a motion for motion data search.

### Step S14

When ending the motion for motion data search, the user 10 executes the motion information recording end operation on the user terminal 20 in step S14.

With this user operation, the user terminal 20 ends the processing of recording the detection values of the sensors worn by the user 10.

### Step S15

Next, in step S15, the data processing unit of the user terminal 20 executes processing of extracting motion data search motion information to be transmitted to the motion data providing server 30.

This processing corresponds to the data extraction processing of the user terminal 20 described above with reference to FIG. 13 and FIG. 16.

That is, in the example illustrated in FIG. 13, a pose matching poses of the following two poses, that is,
(p) search motion information start position identification pose and
(q) search motion information end position identification pose
are detected from the action sequence of the user 10 recorded in the user terminal 20, and data in the section interposed between the detected pose positions (p) and (q), that is, the area of (b) to (d) illustrated in FIG. 13 is extracted as motion data search motion information.

Furthermore, in the example illustrated in FIG. 16, two pose set positions of
a first pose set including
(r) identification pose execution preliminary notification pose, and
(p) search motion information start position identification pose, and
a second pose set including
(r) identification pose execution preliminary notification pose, and
(q) search motion information end position identification pose
are detected from the action sequence of the user 10 recorded in the user terminal 20.

Moreover, data of the section interposed between the detected two pose sets (r) and (p) and (r) and (q), that is, the area of (b) to (d) illustrated in FIG. 16 is extracted as motion data search motion information.

### Step S16

Next, in step S16, the user terminal 20 transmits the “motion data search motion information” extracted in step S15 to the motion data providing server 30.

### Step S17

The processing in step S17 is processing executed by the motion data providing server 30.

The motion data providing server 30 executes search processing for motion data based on the “motion data search motion information” received from the user terminal 20.

That is, the motion data providing server 30 executes search processing of extracting motion data similar to the “motion data search motion information” received from the user terminal 20 from a large number of pieces of motion data stored in the database.

### Step S18

Next, the motion data providing server 30 transmits, to the user terminal 20, motion data extracted from the database as a result of the search processing in step S17, that is, motion data similar to the “motion data search motion information” received from the user terminal 20 as a search result.

### Step S19

Finally, the user terminal 20 displays the search result received from the motion data providing server 30 on the user terminal 20.

Note that the search result is motion data similar to the “motion data search motion information” transmitted from the user terminal 20, that is, “motion data search motion information” not including an extra action such as a terminal operating action, and is motion data desired by the user 10.

Note that, after this processing, motion data purchase processing is executed between the user terminal 20 and the motion data providing server 30. This processing will be described later.

As described above, the motion data transmitted to the user terminal 20 at the motion data search processing stage is data for preview of the motion data, and is, for example, simple moving image data (low-resolution moving image data) having a data size smaller than that of the motion data body in the BVH data (BVH file) format, thumbnail images indicating representative images in the motion data, or the like.

By the user 10 performing motion data purchase processing, the motion data body is transmitted from the motion data providing server 30 to the user terminal 20.

Note that it is also possible to transmit the motion data body to the user terminal 20 at the motion data search processing stage.

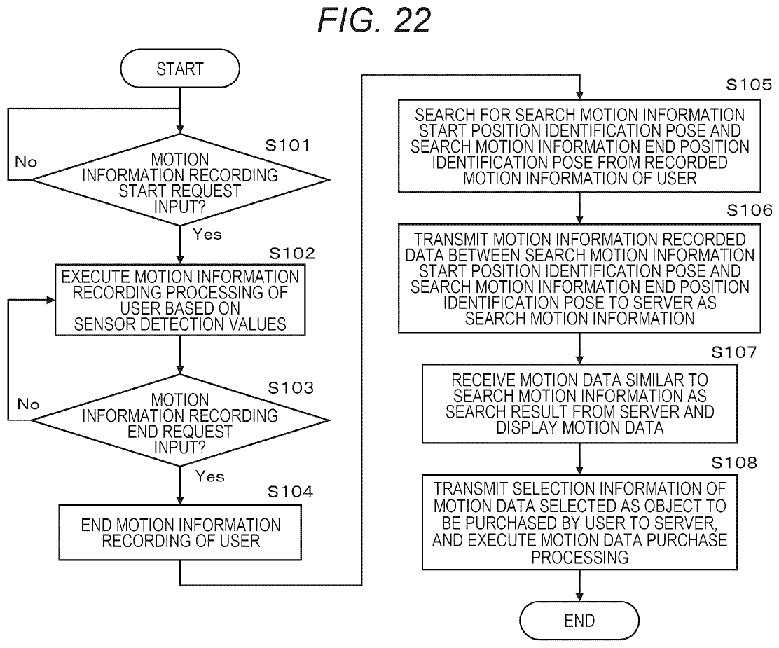

Next, a processing sequence executed by the user terminal 20 will be described with reference to a flowchart illustrated in FIG. 22.

Note that the flow illustrated in FIG. 22 is a flow describing a processing sequence corresponding to the processing of the user terminal 20 described above with reference to FIG. 13.

That is, it is a flowchart describing a sequence of processing in which the user terminal 20 searches for the search motion information start position identification pose and the search motion information end position identification pose from the recorded data based on the sensor detection values, and transmits motion information recorded data between the two poses as search motion information to the motion data providing server.

Hereinafter, the processing of each step illustrated in the flow will be sequentially described.

### Step S101

First, in step S101, the user terminal determines whether or not a motion information recording start request has been input by the user, and in a case where it is determined that the motion information recording start request has been input, the process proceeds to step S102.

That is, in a case where the motion information recording start operation is performed by the user, the process proceeds to step S102.

### Step S102

In a case where the motion information recording start operation is performed by the user, the user terminal continuously executes processing of receiving and recording the detection values of the sensors worn by the user in step S102.

### Step S103

Next, in step S103, the user terminal determines whether or not a motion information recording end request has been input by the user, and in a case where it is determined that the motion information recording end request has been input, the process proceeds to step S104.

That is, in a case where the motion information recording end operation is performed by the user, the process proceeds to step S104.

### Step S104

In a case where the motion information recording end operation is performed by the user, the user terminal ends the receiving and recording processing of the detection values of the sensors worn on the user in step S104.

### Step S105

Next, in step S105, the user terminal searches for the search motion information start position identification pose and the search motion information end position identification pose from the motion information of the user recorded in the user terminal.

### Step S106

Next, in step S106, the user terminal transmits motion information recorded data between the search motion information start position identification pose and the search motion information end position identification pose to the motion data providing server as search motion information.

### Step S107

Next, in step S107, the user terminal receives motion data similar to the search motion information from the motion data providing server as a search result and displays the motion data.

### Step S108

Next, in step S108, the user terminal transmits selection information of the motion data selected as an object to be purchased by the user to the server, and executes motion data purchase processing.

Note that details of the motion data purchase processing will be described later in detail.

The flow illustrated in FIG. 22 is a flow describing a processing sequence corresponding to the processing of the user terminal 20 described above with reference to FIG. 13, and in steps S105 to S106, the search motion information start position identification pose and the search motion information end position identification pose are retrieved, and the motion information recorded data between these two poses is transmitted to the motion data providing server as the search motion information.

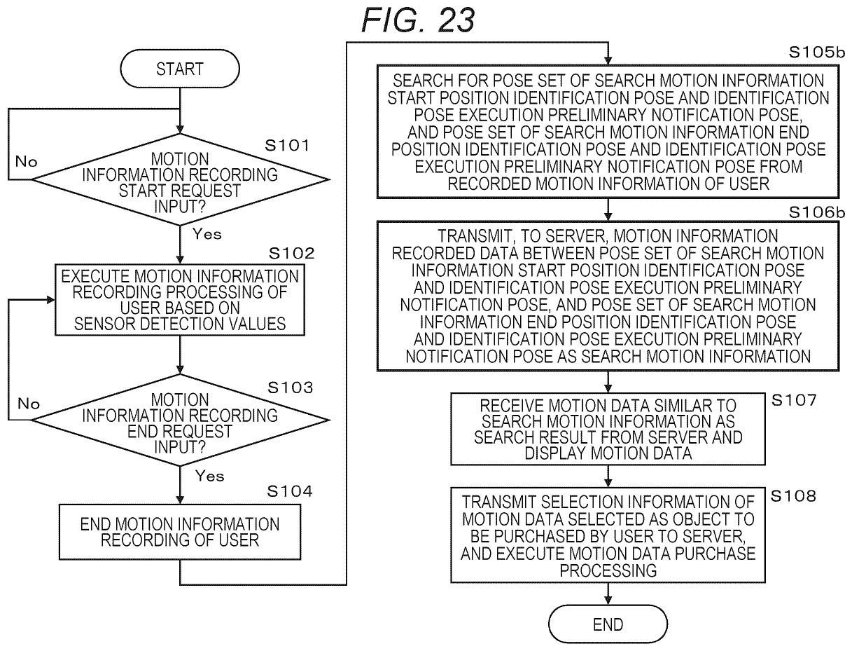

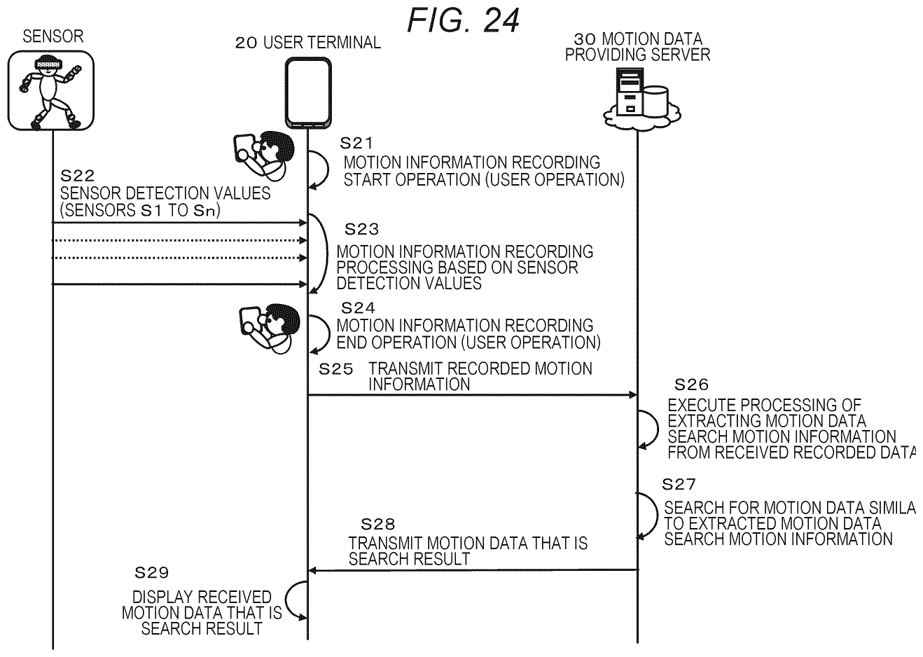

On the other hand, FIG. 23 illustrates a flow describing a processing sequence corresponding to the processing of the user terminal 20 described above with reference to FIG. 16.

Namely, it is a processing sequence of the user terminal 20 in a case where the user terminal 20 executes processing of detecting a pose set of the search motion information start position identification pose and the identification pose execution preliminary notification pose, and a pose set of the search motion information end position identification pose and the identification pose execution preliminary notification pose, and transmitting the motion information recorded data between these two detected pose sets to the motion data providing server as the search motion information.

The flow illustrated in FIG. 23 is different from the flow illustrated in FIG. 22 in that the processing in steps S105 and S106 is changed to steps S105b and S106b. The processing of other steps of the flow illustrated in FIG. 23 is similar to the flow illustrated in FIG. 22.

Hereinafter, step S105b and step S106b of the flow illustrated in FIG. 23 will be described.

### Step S105b

In step S105b, the user terminal searches for the following two pose sets from the motion information of the user recorded in the user terminal:
a pose set of the search motion information start position identification pose and the identification pose execution preliminary notification pose; and
a pose set of the search motion information end position identification pose and the identification pose execution preliminary notification pose.

### Step S106b

Next, in step S106b, the user terminal transmits, to the motion data providing server, motion information recorded data between the two pose sets of:
the pose set of the search motion information start position identification pose and the identification pose execution preliminary notification pose, and
the pose set of the search motion information end position identification pose and the identification pose execution preliminary notification pose as the search motion information.

The flow illustrated in FIG. 23 detects a pose set including two poses in this manner, and transmits motion data between the pose sets to the motion data providing server as search motion information.

By performing this process, the error occurrence probability can be reduced as compared with a case where only a single pose is used.

Next, the sequence of the processing described above with reference to FIGS. 14 and 17 will be described with reference to the sequence diagram illustrated in FIG. 24.

Namely, it is a sequence in a case where the user terminal 20 transmits the user action recorded data including the terminal operating action by the user to the motion data providing server 30 as it is, and the motion data providing server 30 executes extraction processing of the “motion data search motion information area” on the basis of the identification pose and executes search processing for motion data on the basis of the extracted data.

Hereinafter, processing of each step of the sequence diagram illustrated in FIG. 24 will be sequentially described.

### Step S21

First, in step S21, the user 10 wearing the sensors executes a motion information recording start operation on the user terminal 20.

That is, an operation for causing the user terminal 20 to start processing of receiving and recording detection values of the worn sensors of the user 10 is executed.

### Steps S22 and S23

When the motion information recording start operation is executed on the user terminal 20 in step S21, the detection values of the sensors worn by the user 10 are sequentially transmitted to the user terminal 20 in steps S22 to S23, and recording processing is executed.

Note that, during this period, the user 10 executes a motion for motion data search.

### Step S24

When ending the motion for motion data search, the user 10 executes the motion information recording end operation on the user terminal 20 in step S24.

With this user operation, the user terminal 20 ends the processing of recording the detection values of the sensors worn by the user 10.

### Step S25

Next, in step S25, the user terminal 20 transmits the recorded detection values of the sensors or user motion data analyzed from the detection values of the sensors to the motion data providing server 30.

The transmission data includes all action sequences of the user 10 recorded in the user terminal 20, that is, all actions of the motion information recording start operation and the motion information recording end operation by the user.

### Step S26

The processing in step S26 is processing executed by the motion data providing server 30.

In step S26, the motion data providing server 30 executes processing of extracting “motion data search motion information” to be applied to the motion data search processing from the user motion data received from the user terminal 20.

This processing corresponds to the data extraction processing of the motion data providing server 30 described above with reference to FIGS. 14 and 17.

That is, in the example illustrated in FIG. 14, a pose matching poses of the following two poses, that is,
(p) search motion information start position identification pose and
(q) search motion information end position identification pose
are detected from the action sequence of the user 10 received from the user terminal 20, and data in the section interposed between the detected pose positions (p) and (q), that is, the area of (b) to (d) illustrated in FIG. 14 is extracted as motion data search motion information.

Furthermore, in the example illustrated in FIG. 17, two pose set positions of
a first pose set including
(r) identification pose execution preliminary notification pose, and
(p) search motion information start position identification pose, and
a second pose set including
(r) identification pose execution preliminary notification pose, and
(q) search motion information end position identification pose
are detected from the action sequence of the user 10 received from the user terminal 20.

Moreover, data of the section interposed between the detected two pose sets (r) and (p) and (r) and (q), that is, the area of (b) to (d) illustrated in FIG. 17 is extracted as motion data search motion information.

### Step S27

Next, in step S27, the motion data providing server 30 executes search processing for motion data based on the “motion data search motion information” extracted in step S26.

That is, the motion data providing server 30 executes search processing of extracting motion data similar to the “motion data search motion information” extracted in step S26 from the large number of pieces of motion data stored in the database.

### Step S28

Next, the motion data providing server 30 transmits, to the user terminal 20, motion data extracted from the database as a result of the search processing in step S27, that is, motion data similar to the “motion data search motion information” received from the user terminal 20 as a search result.

### Step S29

Finally, the user terminal 20 displays the search result received from the motion data providing server 30 on the user terminal 20.

Note that the search result is motion data similar to the “motion data search motion information” extracted in step S26, that is, “motion data search motion information” not including an extra action such as a terminal operating action, and is motion data desired by user 10.

Note that, after this processing, motion data purchase processing is executed between the user terminal 20 and the motion data providing server 30. This processing will be described later.

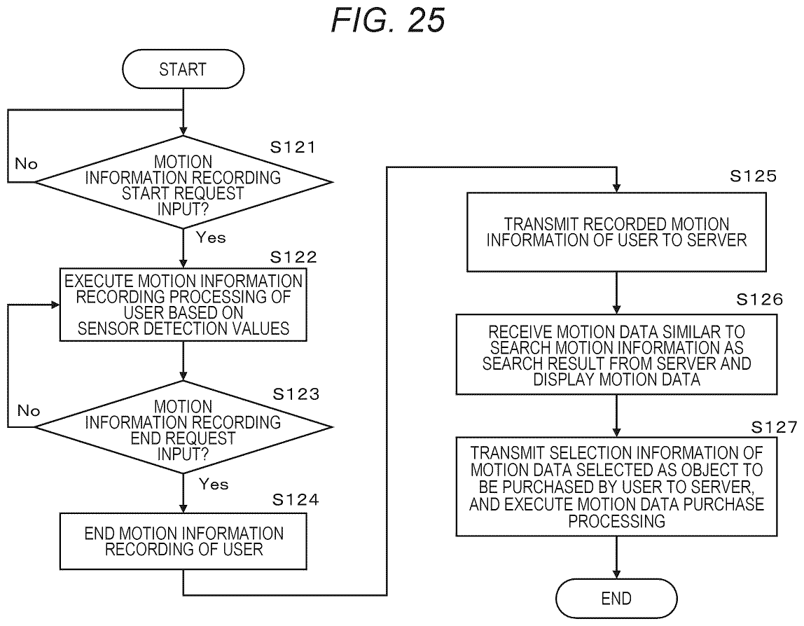

Next, a processing sequence executed by the user terminal 20 will be described with reference to a flowchart illustrated in FIG. 25.

Note that the flow illustrated in FIG. 25 is a flow describing a processing sequence corresponding to the processing of the user terminal 20 described above with reference to FIGS. 14 and 17.

That is, it is a flowchart describing a processing sequence in a case where the user terminal 20 transmits the recorded data based on the sensor detection values as it is to the motion data providing server 30.

Hereinafter, the processing of each step illustrated in the flow will be sequentially described.

### Step S121

First, in step S121, the user terminal determines whether or not a motion information recording start request has been input by the user, and in a case where it is determined that the motion information recording start request has been input, the process proceeds to step S122.

That is, in a case where the motion information recording start operation is performed by the user, the process proceeds to step S122.

### Step S122

In a case where the motion information recording start operation is performed by the user, the user terminal continuously executes processing of receiving and recording the detection values of the sensors worn by the user in step S122.

### Step S123

Next, in step S123, the user terminal determines whether or not a motion information recording end request has been input by the user, and in a case where it is determined that the motion information recording end request has been input, the process proceeds to step S124.

That is, in a case where the motion information recording end operation is performed by the user, the process proceeds to step S124.

### Step S124

In a case where the motion information recording end operation is performed by the user, the user terminal ends the reception recording processing of the detection value of the sensor worn on the user in step S124.

### Step S125

Next, in step S125, the user terminal transmits the motion information of the user recorded in the user terminal to the motion data providing server as it is.

The transmission data includes all action sequences of the user 10 recorded in the user terminal 20, that is, all actions of the motion information recording start operation and the motion information recording end operation by the user.

### Step S126

Next, in step S126, the user terminal receives and displays a search result, that is, motion data similar to the search motion information, from the motion data providing server.

Note that this search result is a result of data extraction processing in the motion data providing server, that is, search processing executed on the basis of “motion data search motion information” in which the user terminal operating action or the like is deleted from the user motion data including the user terminal operating action by the user received from the user terminal 20.

### Step S127

Next, in step S127, the user terminal transmits selection information of the motion data selected as the object to be purchased by the user to the server, and executes motion data purchase processing.

Note that details of the motion data purchase processing will be described later in detail.

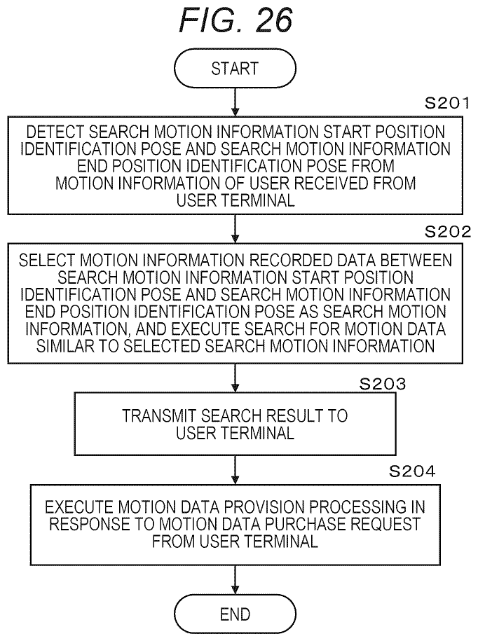

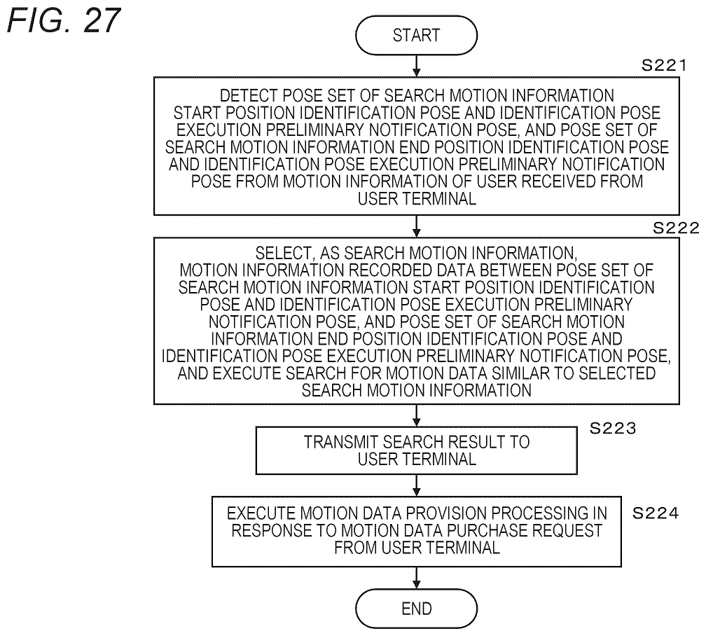

Next, a sequence of processing executed by the motion data providing server 30 when the processing is executed according to the sequence illustrated in FIG. 24 will be described with reference to flowcharts illustrated in FIGS. 26 and 27.

The flow illustrated in FIG. 26 is a flow describing a processing sequence in a case where the processing of FIG. 14 described above is executed, and the flow illustrated in FIG. 27 is a flow describing a processing sequence in a case where the processing of FIG. 17 described above is executed.

First, a processing sequence in a case where the motion data providing server 30 executes the processing of FIG. 14 described above will be described with reference to the flowchart illustrated in FIG. 26.

That is, it is a flowchart describing a sequence in which the motion data providing server 30 searches for the search motion information start position identification pose and the search motion information end position identification pose from the recorded data based on the sensor detection values received from the user terminal 20, and the motion data search processing using the motion information recorded data between these two poses as the search motion information is executed.

The processing of each step of the flow will be sequentially described.

### Step S201

First, in step S201, the motion data providing server detects the search motion information start position identification pose and the search motion information end position identification pose from the motion information of the user received from the user terminal.

Note that the motion information of the user received from the user terminal corresponds to the recorded data 61 illustrated in FIG. 14, is the entire recorded data in the user terminal, and is data including an operation action on the user terminal by the user.

In step S201, the motion data providing server detects the search motion information start position identification pose and the search motion information end position identification pose from the motion information of the user that is recorded data including the user terminal operating action by the user recorded in the user terminal.

### Step S202

Next, in step S202, the motion data providing server selects motion information recorded data between the search motion information start position identification pose and the search motion information end position identification pose detected in step S201 as “motion data search motion information”, and executes search processing for motion data similar to the selected search motion information.

That is, the motion data (b) to (d) illustrated in FIG. 14 is selected as “motion data search motion information”, and search processing for motion data similar to the selected search motion information is executed.

### Step S203

Next, in step S203, the motion data providing server transmits the search result of the search processing in step S202 to the user terminal.

### Step S204

Next, in step S204, the motion data providing server executes motion data provision processing (sales or the like) in response to a motion data purchase request from the user terminal.

Note that details of this motion data purchase processing will be described later.

Next, a processing sequence in a case where the motion data providing server 30 executes the processing of FIG. 17 described above will be described with reference to the flowchart illustrated in FIG. 27.

That is, it is a flowchart describing a sequence in which the motion data providing server 30 detects two pose sets of a pose set of the search motion information start position identification pose and the identification pose execution preliminary notification pose and a pose set of the search motion information end position identification pose and the identification pose execution preliminary notification pose from recorded data based on a sensor detection value received from the user terminal 20, and motion data search processing using the motion information recorded data between the two detected pose sets as the search motion information is executed.

The processing of each step of the flow will be sequentially described.

### Step S221

First, in step S221, the motion data providing server detects
a pose set of the search motion information start position identification pose and the identification pose execution preliminary notification pose, and
a pose set of the search motion information end position identification pose and the identification pose execution preliminary notification pose from the motion information of the user received from the user terminal.

Note that the motion information of the user received from the user terminal corresponds to the recorded data 71 illustrated in FIG. 17, is the entire recorded data in the user terminal, and is data including an operation action on the user terminal by the user.

In step S221, the motion data providing server detects
a pose set of the search motion information start position identification pose and the identification pose execution preliminary notification pose, and
a pose set of the search motion information end position identification pose and the identification pose execution preliminary notification pose from the motion information of the user, which is recorded data including the user terminal operating action by the user recorded in the user terminal.

### Step S222

Next, in step S222, the motion data providing server selects, as “motion data search motion information”, motion information recorded data between the two pose sets of
the pose set of the search motion information start position identification pose and the identification pose execution preliminary notification pose, and
the pose set of the search motion information end position identification pose and the identification pose execution preliminary notification pose detected in step S221, and
executes search processing for motion data similar to the selected search motion information.

That is, the motion data (b) to (d) illustrated in FIG. 17 is selected as “motion data search motion information”, and search processing for motion data similar to the selected search motion information is executed.

### Step S223

Next, in step S223, the motion data providing server transmits the search result of the search processing in step S222 to the user terminal.

### Step S224

Next, in step S224, the motion data providing server executes motion data provision processing (sales or the like) in response to a motion data purchase request from the user terminal.

Note that details of this motion data purchase processing will be described later.

As described with reference to the flows illustrated in FIGS. 26 and 27, the motion data providing server 30 performs processing of detecting an identification pose or a pose set from the recorded data of the user operation and extracting “motion data search motion information”, and performs search processing for motion data using the extracted “motion data search motion information”, so that it is possible to search for motion data similar to only the “motion data search motion information” that does not include the user terminal operating action or the like by the user.

Furthermore, in this processing example, the user terminal 20 side can transmit the recorded data of the user action as it is to the motion data providing server 30, and the processing load on the user terminal 20 side is reduced.

### 6. (Fourth Embodiment) Details of Motion Data Purchase Processing

Next, details of the motion data purchase processing will be described as a fourth embodiment.

By the processing described in the first to third embodiments described above, the user 10 can acquire, from the motion data providing server 30, motion data similar to only the “motion data search motion information” that does not include the user terminal operating action or the like by the user, and display the motion data on the user terminal 20.

However, as described above, the motion data transmitted to the user terminal 20 in the motion data search processing stage is data for preview of the motion data, and is, for example, simple moving image data having a small data size with a lower resolution than that of the motion data body in the BVH data (BVH file) format, thumbnail images indicating representative images in the motion data, or the like.

By the user 10 performing motion data purchase processing, the motion data body is transmitted from the motion data providing server 30 to the user terminal 20.

The user 10 can perform processing of displaying and reproducing a plurality of pieces of motion data acquired from the motion data providing server 30 as a result of the motion data search processing on the user terminal 20, determine motion data to be purchased from among the plurality of pieces of motion data, and perform processing of purchasing the determined motion data.

As described above with reference to FIGS. 1 to 4, the user 10 can display and confirm, on the user terminal 20, reproduced images of the plurality of pieces of motion data extracted by the search processing of the motion data providing server 30. In a case where there is motion data desired to be purchased therein, the user 10 decides to purchase the motion data, and executes communication with the motion data providing server 30 using the user terminal 20 to execute processing necessary for the purchase processing, for example, settlement processing, and the like, whereby the motion data can be purchased.

Note that, as described above, the purchase price of the motion data is different for each piece of motion data, and there may be free motion data.

For example, the price of a batting motion of a famous player in the major league is set high, and a common batting motion is provided free.

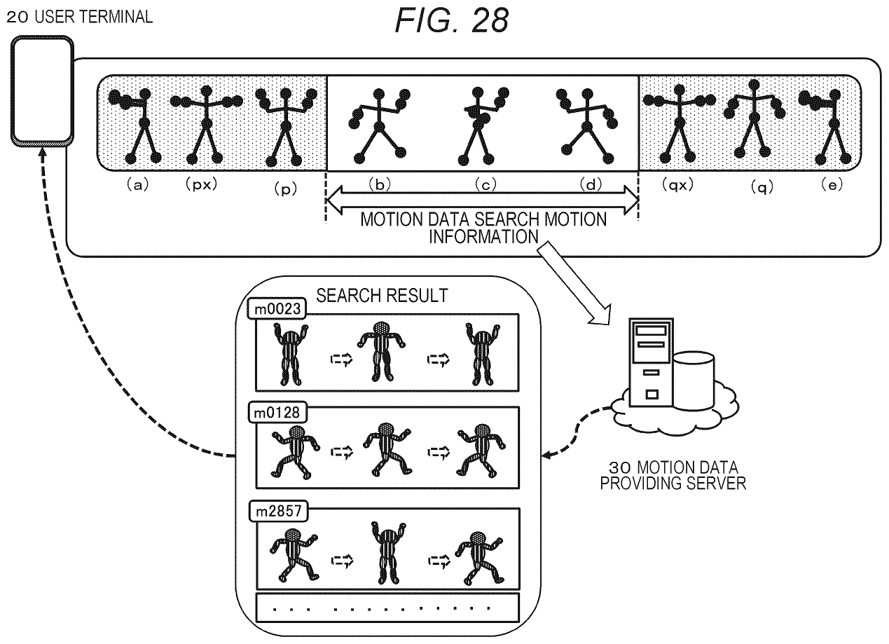

A specific example of the motion data purchase processing will be described with reference to FIG. 28 and subsequent drawings.

FIG. 28 illustrates an example in which the motion data providing server 30 searches for motion data similar to only “motion data search motion information” not including a user terminal operating action or the like by the user, and transmits the search result to the user terminal 20.

The example illustrated in FIG. 28 illustrates an example in which a plurality of pieces of motion data (m0023, m0128, m2857 . . . ) is transmitted to the user terminal 20 as the search result.

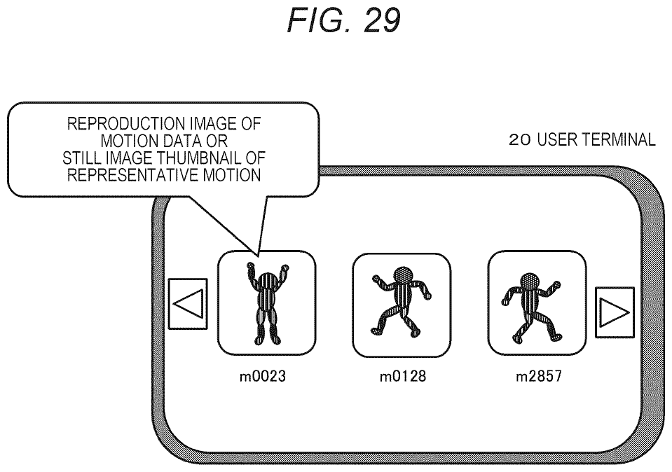

FIG. 29 illustrates a specific example of displaying the received motion data on the display unit of the user terminal 20 that has received a plurality of pieces of motion data (m0023, m0128, m2857, . . . ) as a search result from the motion data providing server 30 to perform reproduction confirmation.

Note that the display unit of the user terminal 20 can display reproduced images of the plurality of pieces of motion data (m0023, m0128, m2857, . . . ) as search results received from the motion data providing server 30, thumbnail images of representative images, and the like.

FIG. 29 illustrates a state in which a plurality of pieces of motion data (m0023, m0128, m2857) is reproduced in parallel.

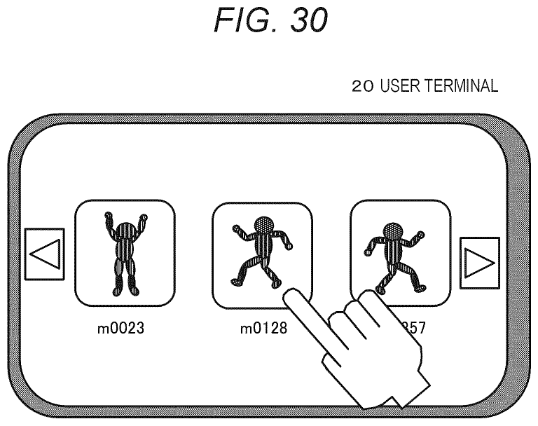

For example, in a case where the user 10 finds motion data desired to be purchased from these pieces of motion data, for example, as illustrated in FIG. 30, the user 10 performs a selection operation (tapping) on the motion data desired to be purchased, for example, the motion data (m0128).

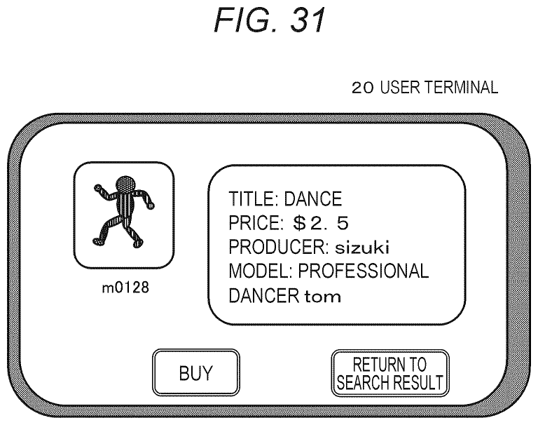

By this user operation, detailed information regarding the selected motion data is displayed, for example, as illustrated in FIG. 31.

Specifically, various detailed information such as a title, a price, a producer, and a model of the motion data is displayed.

Note that the configuration may be such that detailed information of each piece of motion data is displayed together with a motion data list display as the search result illustrated in FIG. 29.

In a case where the user 10 confirms the detailed information of the motion data and determines an intention to purchase, the user operates (taps) the “purchase icon” displayed on the display unit of the user terminal 20 illustrated in FIG. 31.

Thereafter, processing necessary for purchase, such as settlement processing, is executed between the user terminal 20 and the motion data providing server 30, and this motion data can be purchased.

As described above with reference to FIG. 4, the motion data purchased by the user 10 is, for example, the BVH data (BVH file) main body described above, and can be applied to a 3DCG character used in a game application or the like to cause the character to execute an action corresponding to the motion data.

Note that such purchase processing of motion data can also be executed using detection information from a sensor worn on the user 10. That is, selection processing, purchase processing, and the like of motion data can be performed by an action of the user 10.

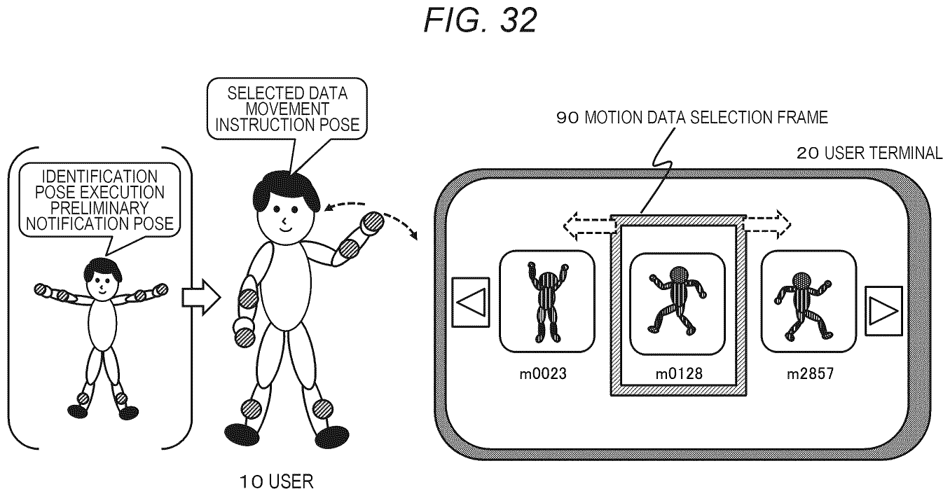

A specific processing example of performing selection processing and purchase processing of motion data by an action of the user 10 will be described with reference to FIG. 32 and subsequent drawings.

FIG. 32 illustrates a user 10 wearing the sensor (motion sensor such as IMU) on each part of the body.

For example, as described above with reference to FIG. 7, the sensors are worn on these eight parts of the right hand, left hand, right arm, left arm, right foot, left foot, head, and waist, and the waist of the user 10, and the motion of each portion is input to the user terminal 20 such as a smartphone.

The example illustrated in FIG. 32 is a processing example of moving a motion data selection frame 90 displayed on the user terminal 20 by the action of the user 10.

A plurality of pieces of motion data acquired as a result of the search processing by the motion data providing server 30 is displayed side by side on the user terminal 20. Each piece of display data of the motion data is a reproduced image of a moving image, a thumbnail image of a representative image, or the like.

The motion data selection frame 90 is a frame indicating motion data to be purchased.

The user 10 can move the motion data selection frame 90 by performing a pose according to the “selected data movement instruction pose” illustrated in the drawing, for example. For example, as illustrated in the drawing, the motion data selection frame 90 can be moved left and right by performing an action of swinging the left hand left and right.

As illustrated in the drawing, when the user 10 performs a pose according to the “selected data movement instruction pose” and swings the left hand leftward, the motion data selection frame 90 moves leftward, and when the user performs an action of swinging the left hand rightward, the motion data selection frame 90 moves rightward.

Note that the configuration may be such that a prescribed “identification pose execution preliminary notification pose” is executed before the “selected data movement instruction pose” is executed. That is, similarly to the second embodiment described above, the configuration may be such that a pose set including two poses is used.

Similarly to the first embodiment described above, only the “selected data movement instruction pose” may be executed without executing the “identification pose execution preliminary notification pose”.

Note that, in any case, the “selected data movement instruction pose” or a pose set of the “identification pose execution preliminary notification pose” and the “selected data movement instruction pose” need to be registered in the user terminal 20 in advance.

That is, correspondence data of the pose or pose set and the processing to be executed by the user terminal 20 is registered in the storage unit of the user terminal 20, and the data processing unit of the user terminal 20 executes collation processing between the user's pose analyzed from the sensor detection values and the registration data, and executes the processing illustrated in FIG. 32, that is, the processing of moving the motion data selection frame 90 in a case where the collation is established.

The example illustrated in FIG. 32 illustrates a state in which the user 10 performs a pose according to the “selected data movement instruction pose” and swings the left hand to set the motion data selection frame 90 to one piece of motion data m0128 displayed on the user terminal 20.

In this state, when the user 10 performs a predetermined action, detailed information display processing, purchase processing, or the like of the motion data m0128 to which the motion data selection frame 90 has been set can be performed.

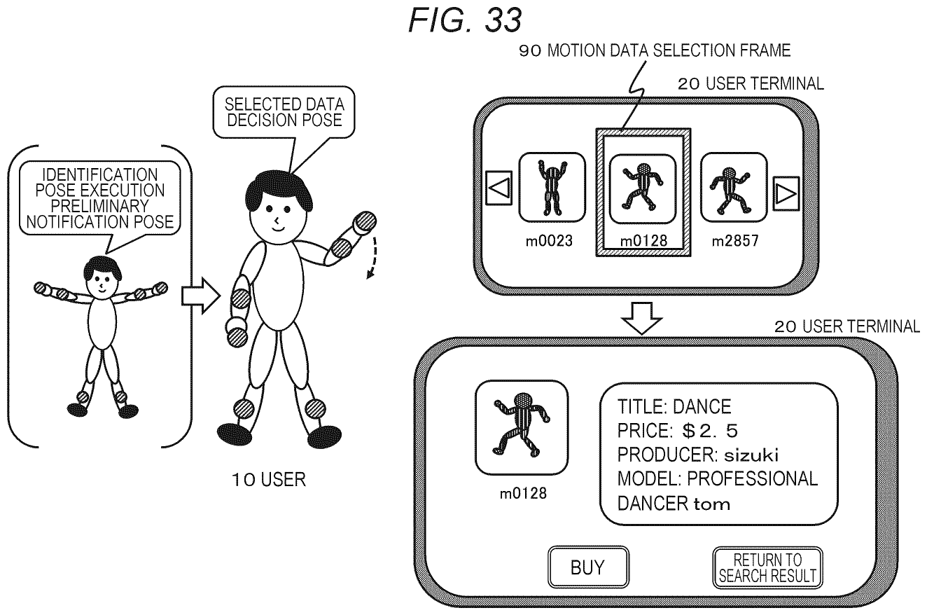

FIG. 33 illustrates a detailed information display processing example of the motion data m0128 to which the motion data selection frame 90 is set.

As illustrated in FIG. 33, when the user 10 performs a pose according to “selected data decision pose” and shakes the left hand up and down, detailed information of the motion data m0128 to which the motion data selection frame 90 is set is displayed.

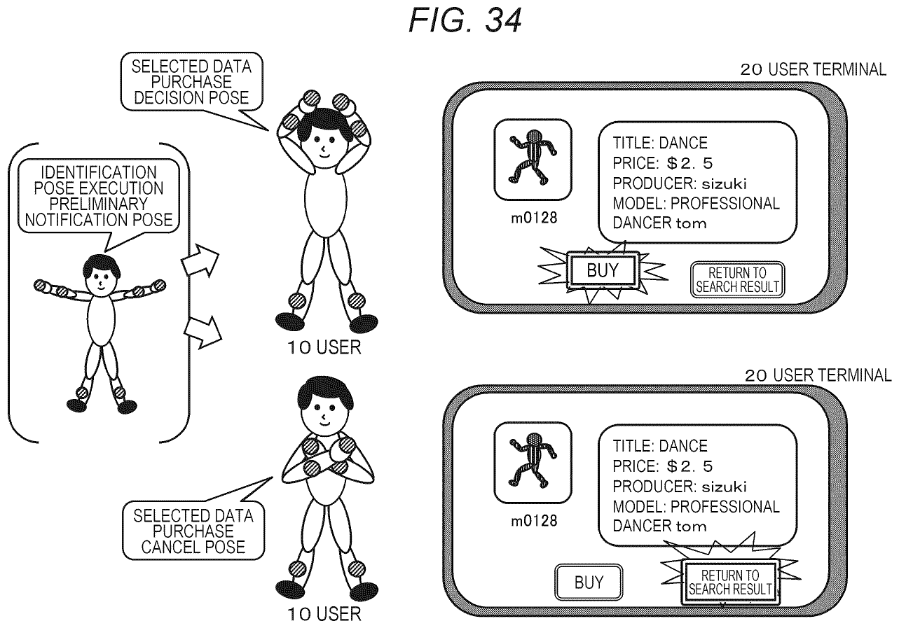

Furthermore, FIG. 34 illustrates processing examples of purchase processing and purchase cancel processing of the motion data m0128 to which the motion data selection frame 90 is set.

As illustrated in the upper part of FIG. 34, by the user 10 performing a pose according to the “selected data purchase decision pose”, for example, a pose indicating a “o shape” sign of putting both hands above the head, the purchase processing of the motion data m0128 to which the motion data selection frame 90 is set is performed.

On the other hand, as illustrated in the lower part of FIG. 34, by the user 10 performing a pose according to the “selected data purchase decision cancel pose”, for example, a pose indicating a “x shape” sign of intersecting both hands on the chest, the purchase cancel processing of the motion data m0128 to which the motion data selection frame 90 is set is performed.

Note that the correspondence data between each pose illustrated in FIGS. 33 and 34 and the processing to be executed is registered in the user terminal 20 in advance, and the data processing unit of the user terminal 20 executes the collation processing between the user's pose analyzed from the sensor detection value and the registration data, and executes each processing illustrated in FIGS. 33 and 34 in a case where the collation is established.

Note that, in both cases of FIGS. 33 and 34, as described above with reference to FIG. 32, the configuration may be such that a prescribed “identification pose execution preliminary notification pose” is executed before each pose is executed.

That is, similarly to the second embodiment described above, the configuration may be such that a pose set including two poses is used.

As in the first embodiment described above, the setting may be such that the “identification pose execution preliminary notification pose” is not executed.

Note that each pose described with reference to FIGS. 32 to 34 is an example, and not limited to these poses, various poses can be registered and used in the user terminal 20.

While the processing example illustrated in FIGS. 32 to 34 is a processing example in which the motion data as a search result is displayed on the user terminal 20 such as a smartphone and the purchase processing is performed, for example, it is also possible to perform processing in which the motion data as a search result is displayed on the VR goggles 80 worn by the user 10 and the purchase processing is performed.

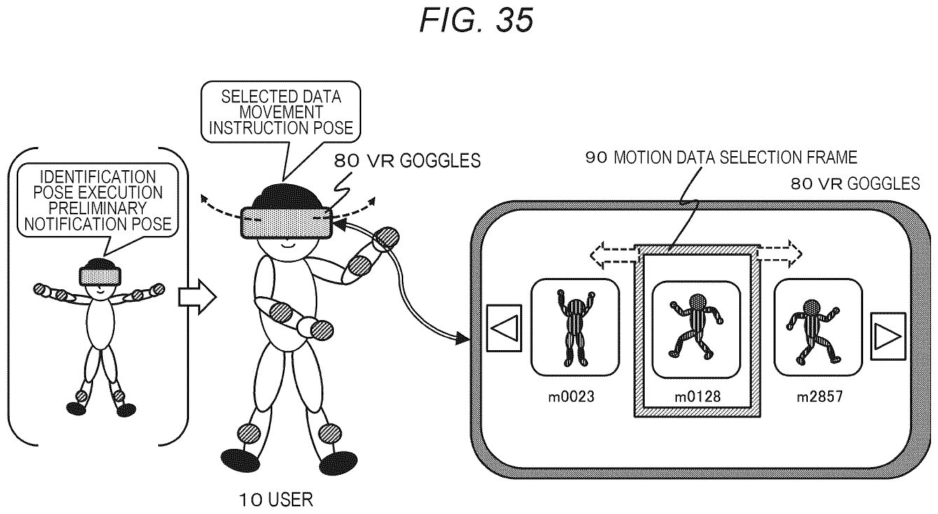

This processing example will be described with reference to FIG. 35 and subsequent drawings.

FIG. 35 illustrates the user 10 wearing the sensor (motion sensor such as IMU) on each part of the body and VR goggles 80.

For example, as described above with reference to FIG. 7, the sensors are worn on these eight parts of the right hand, left hand, right arm, left arm, right foot, left foot, head, and waist, and the waist of the user 10, and the motion of each portion is input to the user terminal 20 such as a smartphone.

Furthermore, in a case where a motion sensor is attached to the VR goggles 80, a detection value of the motion sensor of the VR goggles 80 is also input to the user terminal 20 such as a smartphone.

The example illustrated in FIG. 35 is a processing example in which the motion data selection frame 90 displayed on a display unit of the VR goggles 80 is moved by the action of the user 10 wearing the VR goggles 80. This is a processing example similar to that described above with reference to FIG. 32.

The user 10 wearing the VR goggles 80 can move the motion data selection frame 90 displayed on the display unit of the VR goggles 80 by performing a pose according to the “selected data movement instruction pose”. For example, as illustrated in the drawing, the motion data selection frame 90 can be moved left and right by performing an action of swinging the left hand left and right.

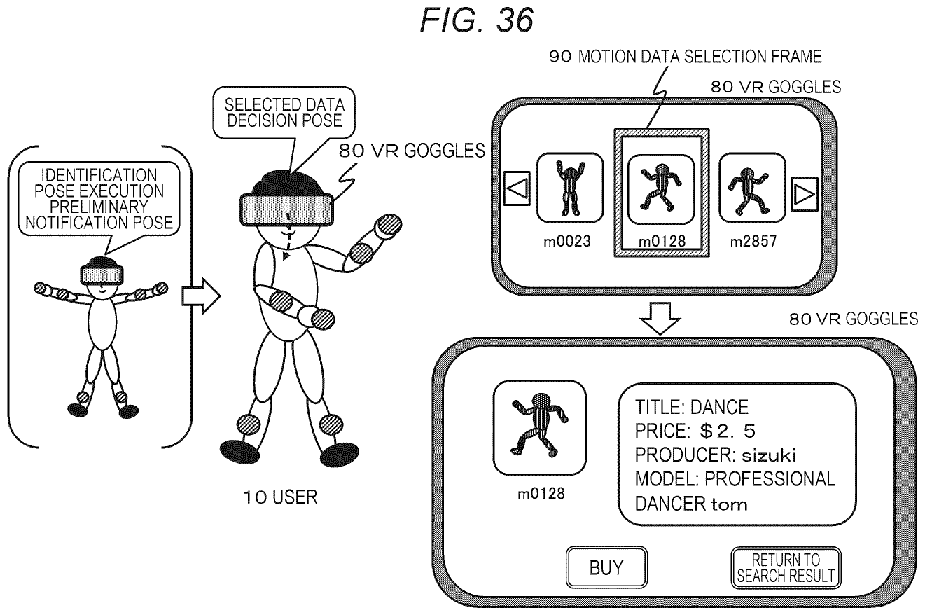

FIG. 36 illustrates a detailed information display processing example of the motion data m0128 to which the motion data selection frame 90 is set, similarly to the description with reference to FIG. 33.

As illustrated in FIG. 36, when the user 10 wearing the VR goggles 80 performs a pose according to the “selected data decision pose” and swings the left hand up and down, detailed information of the motion data m0128 to which the motion data selection frame 90 displayed on the display unit of the VR goggles 80 is set is displayed.

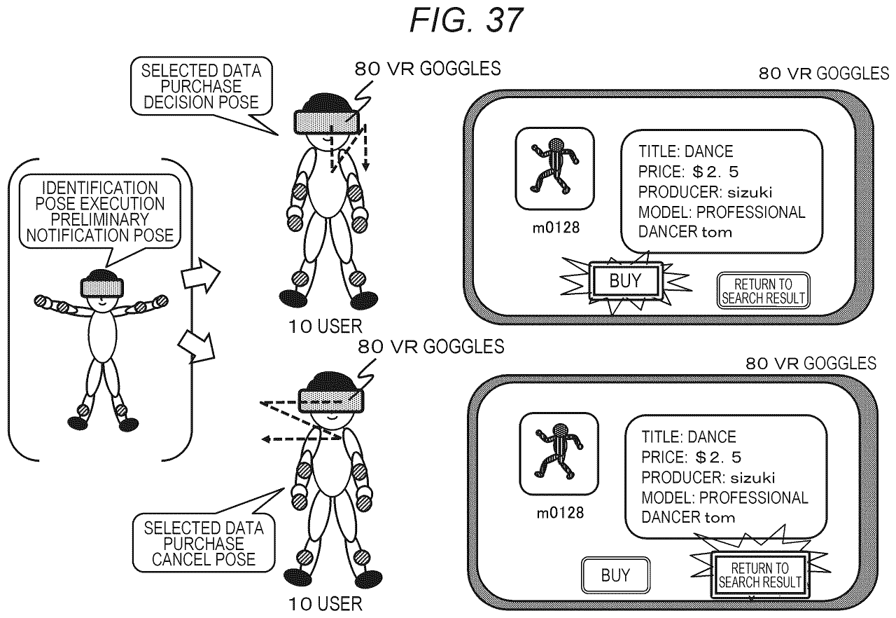

Moreover, similarly to FIG. 34 described above, FIG. 37 illustrates each processing example of the purchase processing and the purchase cancel processing of the motion data m0128 to which the motion data selection frame 90 is set.

As illustrated in the upper part of FIG. 37, by the user 10 wearing the VR goggles 80 performing a pose according to the “selected data purchase decision pose”, for example, a pose indicating a “o shape” sign of putting both hands above the head, the purchase processing of the motion data m0128 to which the motion data selection frame 90 displayed on the display unit of the VR goggles 80 is set is performed.

On the other hand, as illustrated in the lower part of FIG. 37, by the user 10 wearing the VR goggles 80 performing a pose according to the “selected data purchase decision cancel pose”, for example, a pose indicating a “x shape” sign of intersecting both hands on the chest, the purchase cancel processing of the motion data m0128 to which the motion data selection frame 90 displayed on the display unit of the VR goggles 80 is set is performed.

Note that the correspondence data between each pose illustrated in FIGS. 35 to 37 and the processing to be executed is registered in the user terminal 20 in advance, and the data processing unit of the user terminal 20 executes the collation processing between the user's pose analyzed from the sensor detection value and the registration data, and executes each processing illustrated in FIGS. 35 to 37 in a case where the collation is established.

Furthermore, in any case of FIGS. 35 to 37, the configuration may be such that a prescribed “identification pose execution preliminary notification pose” is executed before each pose is executed. That is, similarly to the second embodiment described above, the configuration may be such that a pose set including two poses is used.

As in the first embodiment described above, the setting may be such that the “identification pose execution preliminary notification pose” is not executed.

Note that, in any of the processing example in which the motion data as a search result is displayed on the user terminal 20 such as a smartphone described with reference to FIGS. 32 to 34 and the purchase processing is performed and the processing example in which the motion data as a search result is displayed on the VR goggles 80 described with reference to FIGS. 35 to 37 and the purchase processing is performed, not only the user action but also various processes can be performed by directly operating the switch or the UI set in the user terminal 20 or the VR goggles 80.

Furthermore, in a case where the VR goggles 80 are configured to be able to perform communication processing with sensors or communication processing with the motion data providing server 30, processing in which the VR goggles 80 receive sensor detection values and transmit the sensor detection values to the motion data providing server 30 without using the user terminal 20 such as a smartphone may be performed.

With such a configuration, the user terminal 20 such as a smartphone can be omitted.

### 7. Configuration Example of Information Processing Device

Next, configuration examples of a user terminal such as a smartphone, VR goggles, and an information processing device such as a motion data providing server used for the processing of the present disclosure will be described.

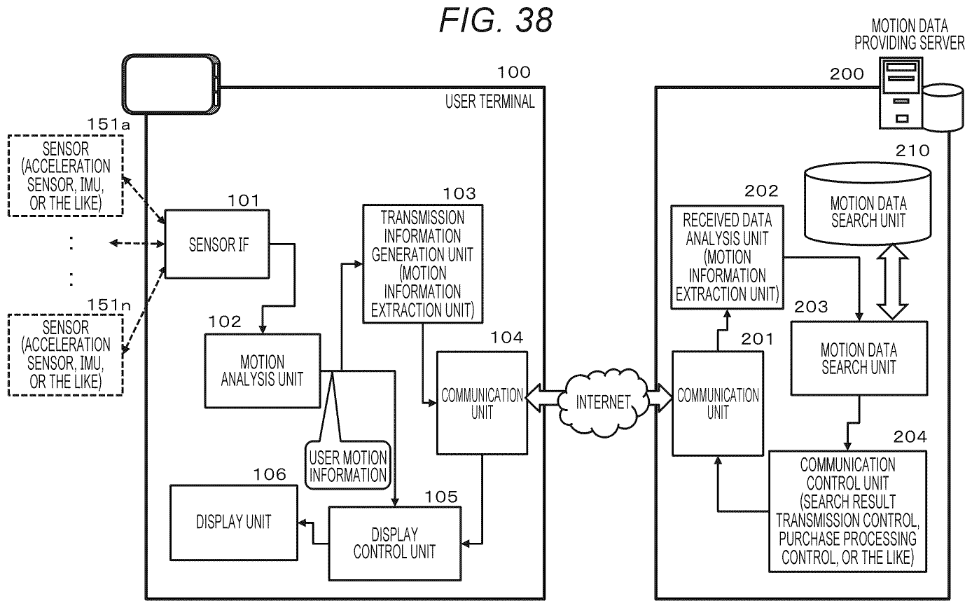

FIG. 38 is a diagram illustrating configuration examples of a user terminal such as a smartphone, VR goggles, and an information processing device such as a motion data providing server.

Note that a configuration example of the user terminal 100 such as a smartphone is illustrated on the left side of FIG. 38, and a configuration example of the motion data providing server 200 is illustrated on the right side.

The user terminal 100 illustrated on the left side is a configuration of a user terminal such as a smartphone or a PC, for example. However, the user terminal 100 may be, for example, VR goggles having functions of a smartphone or a PC (functions such as data processing and communication).

First, the configuration of the user terminal 100 on the left side will be described.

The user terminal 100 includes a sensor IF 101, a motion analysis unit 102, a transmission information generation unit (motion information extraction unit) 103, a communication unit 104, a display control unit 105, and a display unit 106.

The sensor IF 101 is an IF corresponding to sensors (motion sensors) 151 such as the IMUs worn on the respective parts of the user's body, for example, the right hand, left hand, right arm, left arm, right foot, left foot, head, waist, and the like as described above with reference to FIG. 7, and executes data transmission and reception with these sensors 151. For example, the sensor IF is an IF that performs proximity communication such as Bluetooth (registered trademark) communication.

Note that the sensors 151 are not limited to sensors (motion sensors) such as IMUs, and for example, a configuration using a camera as a sensor is also possible. For example, a configuration is possible in which a user performing an action is captured by a camera such as a smartphone, and processing of specifying motion (motion of the user) is performed by analyzing a captured image (image recognition or the like).

The motion analysis unit 102 executes processing of analyzing the motion of the user by inputting the detection values of the sensors worn on the respective parts (the right hand, left hand, right arm, left arm, right foot, left foot, head, waist, and the like) of the user's body input via the sensor IF 101.

In user motion analysis processing executed in the motion analysis unit 102, for example, the following processing is sequentially executed to analyze the motion of the user and generate the motion information of the user.
(Processing 1) Sensor detection value input processing
(Processing 2) Noise removal processing
(Processing 3) Motion vector group generation processing
(Processing 4) Motion estimation processing

The motion analysis unit 102 sequentially executes, for example, each of these (Processing 1) to (Processing 4) to generate the “motion information (transform data)” of the user.

The transmission information generation unit (motion information extraction unit) 103 executes processing of extracting transmission data to be transmitted to the motion data providing server 200 from the motion information of the user generated by the motion analysis unit 102 on the basis of the sensor detection values.

Specifically, for example, the transmission data generation processing described above with reference to FIGS. 13 and 16 is executed. That is, processing of detecting, from the user motion information including the terminal operating action by the user generated by the motion analysis unit 102 on the basis of the sensor detection values, identification poses of:
(p) search motion information start position identification pose, and
(q) search motion information end position identification pose,
executing processing of extracting the “motion data search motion information area” on the basis of the detected identification poses, and generating extracted data as transmission data to be transmitted to the motion data providing server 200 is executed.

Alternatively, processing of detecting, from the user motion information including the terminal operating action by the user generated by the motion analysis unit 102 on the basis of the sensor detection values, two pose sets of:
a first pose set including
(r) identification pose execution preliminary notification pose, and
(p) search motion information start position identification pose, and
a second pose set including
(r) identification pose execution preliminary notification pose, and
(q) search motion information end position identification pose,
executing processing of extracting a “motion data search motion information area” on the basis of the detected two pose sets, and generating extracted data as transmission data to be transmitted to the motion data providing server 200 is executed.

The communication unit 104 executes communication with the motion data providing server 200.

For example, transmission data including “motion data search motion information” generated by the transmission information generation unit (motion information extraction unit) 103 of the user terminal 100 is transmitted to the motion data providing server 200.

The communication unit 104 further receives motion data as a search result executed in the motion data providing server 200, and outputs the motion data to the display control unit 105. Furthermore, communication processing related to the niu processing executed between the user terminal 100 and the motion data providing server 200 is also performed.

The display control unit 105 performs display control for displaying the motion data as a search result received from the motion data providing server 200 on the display unit 106.

Moreover, the display control unit 105 also executes display control according to the motion of the user analyzed by the motion analysis unit 102.

Specifically, for example, display control of the motion data selection frame 90 according to the motion of the user, display control of detailed information of the motion data, control of the display data regarding the motion data purchase processing, and the like described above with reference to FIGS. 32 to 37 are executed.

The display unit 106 displays various data under the control of the display control unit 105.

That is, the motion data as a search result received from the motion data providing server 200, for example, the motion data selection frame 90 described above with reference to FIGS. 32 to 37, the detailed information of the motion data, the data regarding the motion data purchase processing, and the like are displayed.

Next, a configuration of the motion data providing server 200 will be described.

As illustrated in the drawing, the motion data providing server 200 includes a communication unit 201, a received data analysis unit (motion information extraction unit) 202, a motion data search unit 203, a communication control unit 204, and a motion data storage unit 210.

The motion data providing server 200 inputs the user motion information indicating the user motion from the user terminal 100 such as a smartphone via the communication unit 201.

In a case where terminal operation information or the like by the user is included in the user motion information indicating the user motion received from the user terminal 100 such as a smartphone, the received data analysis unit (motion information extraction unit) 202 executes processing of deleting these pieces of motion information.

Specifically, for example, the search data generation processing described above with reference to FIGS. 14 and 17 is executed. In other words, identification poses of
(p) search motion information start position identification pose and
(q) search motion information end position identification pose
are detected from the user motion information received from the user terminal 100, that is, the user motion information including the terminal operating action by the user, and the processing of extracting the “motion data search motion information area” is executed on the basis of the detected identification poses, and the extracted data is output as the motion data search data to the motion data search unit 203.

Alternatively, from the user motion information received from the user terminal 100, that is, the user motion information including the terminal operating action by the user, two pose sets of
a first pose set including
(r) identification pose execution preliminary notification pose, and
(p) search motion information start position identification pose, and
a second pose set including
(r) identification pose execution preliminary notification pose, and
(q) search motion information end position identification pose
are detected, extraction processing of the “motion data search motion information area” is executed on the basis of the two detected pose sets, and the extracted data is output as motion data search data to the motion data search unit 203.

The motion data search unit 203 executes data search processing of extracting motion data similar to the motion information from the motion data storage unit 210 by using the “motion data search motion information” generated by the received data analysis unit (motion information extraction unit) 202.

The motion information of the user applied to the search processing is motion information that does not include a terminal operating action or the like by the user, and motion data desired by the user can be extracted with high accuracy.

The communication control unit 204 performs control and the like to transmit the motion data as a search result searched by the motion data search unit 203 to the user terminal 100 via the communication unit 201.

Moreover, communication control and the like related to motion data purchase processing executed with the user terminal 100 via the communication unit 201 are also executed.

### 8. Example of Hardware Configuration of Information Processing Device

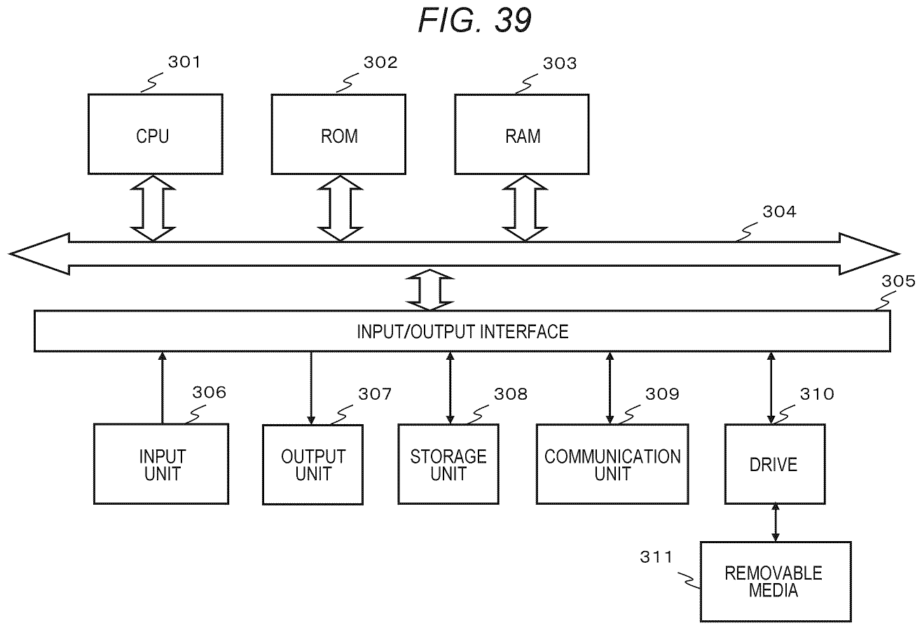

Next, a hardware configuration example of the user terminal, the VR goggles, and the information processing device constituting the motion data providing server or the like that execute processing according to the above-described embodiment will be described with reference to FIG. 39.

Hardware illustrated in FIG. 39 is an example of a hardware configuration of the information processing device, for example, the user terminal such as a PC or a smartphone, the VR goggles, and the information processing device constituting the motion data providing server or the like of the present disclosure.

The hardware configuration illustrated in FIG. 39 will be described.

A central processing unit (CPU) 301 functions as a data processing unit that executes various types of processing in accordance with a program stored in a read only memory (ROM) 302 or a storage unit 308. For example, the CPU 301 executes the processing according to the sequence described in the above-described example. A random access memory (RAM) 303 stores programs, data, or the like to be performed by the CPU 301. The CPU 301, the ROM 302, and the RAM 303 are connected to one another by a bus 304.

The CPU 301 is connected to an input/output interface 305 via the bus 304, and an input unit 306 including various sensors, a camera, a switch, a microphone, and the like, and an output unit 307 including a display, a speaker, and the like are connected to the input/output interface 305.

The storage unit 308 connected to the input/output interface 305 includes, for example, a hard disk, or the like and stores programs executed by the CPU 301 and various types of data. A communication unit 309 functions as a transmitter and receiver for data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

### 9. Summary of Configuration of Present Disclosure

The examples of the present disclosure have been described above in detail with reference to specific examples. However, it is obvious that those skilled in the art can modify or substitute the example without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.
(1) An information processing device including a motion information extraction unit that extracts motion data search motion information from user motion information analyzed on the basis of sensor detection values of motion sensors worn on a plurality of parts of a body of a user, in which
the motion information extraction unit
detects identification poses of:
(p) search motion information start position identification pose; and
(q) search motion information end position identification pose,
from the user motion information, and extracts motion information between the detected identification poses as motion data search motion information.
(2) The information processing device according to (1), in which
the motion information extraction unit
detects two pose sets of:
a first pose set including (r) identification pose execution preliminary notification pose, and (p) search motion information start position identification pose; and
a second pose set including (r) identification pose execution preliminary notification pose, and (q) search motion information end position identification pose,
from the user motion information, and extracts motion information between the two detected pose sets as motion data search motion information.
(3) The information processing device according to (1) or (2), in which
the (p) search motion information start position identification pose is a pose executed by the user at a time point after the user performs a user terminal operation and before the motion data search motion starts, and
the (q) search motion information end position identification pose is a pose executed by the user at a time point after the motion data search motion by the user ends and before the user terminal operation.
(4) The information processing device according to any one of (1) to (3), further including:
a user motion analysis unit that analyzes a user motion by inputting sensor detection values of motion sensors worn on a plurality of parts of a body of a user, in which
the motion information extraction unit
executes processing of extracting motion data search motion information from the user motion information analyzed by the user motion analysis unit.
(5) The information processing device according to (4), further including:
a communication unit that transmits
the motion data search motion information extracted by the motion information extraction unit to a motion data providing server that executes motion data search processing.
(6) The information processing device according to (4) or (5), further including:
a display unit that displays a search result received from the motion data providing server and being a search result of motion data similar to the motion data search motion information.
(7) The information processing device according to (6), in which the display unit is a display unit of a user terminal of either a portable terminal or a goggle-type terminal.
(8) The information processing device according to (6) or (7), in which the motion data as a search result received from the motion data providing server is at least one of moving image data having a lower resolution and a smaller data size than a motion data body or a thumbnail image.
(9) The information processing device according to (1) to (8), further including:
a display control unit that analyzes a user request for motion data displayed on a display unit on the basis of the user motion information analyzed by the user motion analysis unit, and executes display control reflecting the user request as an analysis result.
(10) The information processing device according to (9), in which
the user request
is a motion data selection request from a plurality of pieces of motion data displayed on the display unit, and
the display control unit
executes display control enabling identification of motion data selected from the plurality of pieces of motion data displayed on the display unit in response to the data selection request.
(11) The information processing device according to (9) or (10), in which
the user request
is a purchase request for motion data displayed on the display unit, and
the display control unit executes
display control for purchase processing of the motion data displayed on the display unit in response to the purchase request.
(12) The information processing device according to any one of (1) to (11), in which
the information processing device
is a motion data providing server capable of communicating with a user terminal, and
includes a communication unit that receives user motion information from the user terminal, and
the motion information extraction unit
executes processing of extracting motion data search motion information from the user motion information received from the user terminal.
(13) The information processing device according to (12), further including:
a motion data search unit that searches for motion data similar to the motion data search motion information on the basis of the motion data search motion information extracted by the motion information extraction unit.
(14) The information processing device according to (12) or (13), in which the communication unit transmits, to the user terminal, motion data similar to the motion data search motion information that is a search result of a motion data search unit.
(15) The information processing device according to (14), in which the motion data as the search result transmitted to the user terminal is at least one of a motion data body, moving image data having a lower resolution and a smaller data size than the motion data body or a thumbnail image.
(16) An information processing method executed in an information processing device, in which
the information processing device includes a motion information extraction unit that extracts motion data search motion information from user motion information analyzed on the basis of sensor detection values of motion sensors worn on a plurality of parts of a body of a user, and
the information processing method includes:
detecting, by the motion information extraction unit, identification poses of:
(p) search motion information start position identification pose; and
(q) search motion information end position identification pose,
from the user motion information, and extracting motion information between the detected identification poses as motion data search motion information.
(17) The information processing method according to (16), in which
the motion information extraction unit
detects two pose sets of:
a first pose set including (r) identification pose execution preliminary notification pose, and (p) search motion information start position identification pose; and
a second pose set including (r) identification pose execution preliminary notification pose, and (q) search motion information end position identification pose,
from the user motion information, and extracts motion information between the two detected pose sets as motion data search motion information.

A series of processing tasks described herein may be executed by hardware, software, or a composite configuration of both. In a case where processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed into a computer from a recording medium, the program can be received via a network such as a local area network (LAN) or the Internet, and installed into a recording medium such as an internal hard disk or the like.

Note that the various processes described herein may be executed not only in a chronological order in accordance with the description, but may also be executed in parallel or individually depending on processing capability of a device that executes the processing or depending on the necessity.

Furthermore, a system in the present specification is a logical set configuration of a plurality of devices, and is not limited to a system in which devices of the respective configurations are in the same housing.

### INDUSTRIAL APPLICABILITY

As described above, with a configuration of an embodiment of the present disclosure, a device and a method capable of efficiently and accurately executing search processing for motion data similar to a user motion are implemented.

Specifically, for example, a motion information extraction unit that extracts motion data search motion information from user motion information based on a detection value of a motion sensor worn by the user is included. The motion information extraction unit detects (p) search motion information start position identification pose and (q) search motion information end position identification pose or a set of these and a preliminary notification pose, and extracts motion information between the detected pose or the pose set as motion data search motion information. By applying the extraction result to search for motion data, it is possible to perform highly accurate data search based on motion not including extra motion.

With this configuration, a device and a method capable of efficiently and accurately executing search processing for motion data similar to a user motion are implemented.

### REFERENCE SIGNS LIST

10 User
20 User terminal
30 Motion data providing server
51, 61 Recorded data
62, 72 Transmission data
65, 75 Search data
80 VR goggles
90 Motion data selection frame
100 User terminal
101 Sensor IF
102 Motion analysis unit
103 Transmission information generation unit (motion information extraction unit)
104 Communication unit
105 Display control unit
106 Display unit
200 Motion data providing server
201 Communication unit
202 Received data analysis unit (motion information extraction unit)
203 Motion data search unit
204 Communication control unit
210 Motion data storage unit
301 CPU
302 ROM
303 RAM
304 Bus
305 Input/output interface
306 Input unit
307 Output unit
308 Storage unit
309 Communication unit
310 Drive
311 Removable medium

1. An information processing device comprising a motion information extraction unit that extracts motion data search motion information from user motion information analyzed on a basis of sensor detection values of motion sensors worn on a plurality of parts of a body of a user, wherein
the motion information extraction unit
detects identification poses of:
(p) search motion information start position identification pose; and
(q) search motion information end position identification pose,
from the user motion information, and extracts motion information between the detected identification poses as motion data search motion information.

2. The information processing device according to claim 1, wherein
the motion information extraction unit
detects two pose sets of:
a first pose set including (r) identification pose execution preliminary notification pose, and (p) search motion information start position identification pose; and
a second pose set including (r) identification pose execution preliminary notification pose, and (q) search motion information end position identification pose,
from the user motion information, and extracts motion information between the two detected pose sets as motion data search motion information.

3. The information processing device according to claim 1, wherein
the (p) search motion information start position identification pose is a pose executed by the user at a time point after the user performs a user terminal operation and before the motion data search motion starts, and
the (q) search motion information end position identification pose is a pose executed by the user at a time point after the motion data search motion by the user ends and before the user terminal operation.

4. The information processing device according to claim 1, further comprising:
a user motion analysis unit that analyzes a user motion by inputting sensor detection values of motion sensors worn on a plurality of parts of a body of a user, wherein
the motion information extraction unit
executes processing of extracting motion data search motion information from the user motion information analyzed by the user motion analysis unit.

5. The information processing device according to claim 4, further comprising:
a communication unit that transmits
the motion data search motion information extracted by the motion information extraction unit to a motion data providing server that executes motion data search processing.

6. The information processing device according to claim 4, further comprising:
a display unit that displays a search result received from the motion data providing server and being a search result of motion data similar to the motion data search motion information.

7. The information processing device according to claim 6, wherein
the display unit is a display unit of a user terminal of either a portable terminal or a goggle-type terminal.

8. The information processing device according to claim 6, wherein the motion data as a search result received from the motion data providing server is at least one of moving image data having a lower resolution and a smaller data size than a motion data body or a thumbnail image.

9. The information processing device according to claim 1, further comprising:
a display control unit that analyzes a user request for motion data as a search result displayed on a display unit on a basis of the user motion information analyzed by the user motion analysis unit, and executes display control reflecting the user request as an analysis result.

10. The information processing device according to claim 9, wherein
the user request
is a motion data selection request from a plurality of pieces of motion data displayed on the display unit, and
the display control unit
executes display control enabling identification of motion data selected from the plurality of pieces of motion data displayed on the display unit in response to the data selection request.

11. The information processing device according to claim 9, wherein
the user request
is a purchase request for motion data displayed on the display unit, and
the display control unit executes
display control for purchase processing of the motion data displayed on the display unit in response to the purchase request.

12. The information processing device according to claim 1, wherein
the information processing device
is a motion data providing server capable of communicating with a user terminal, and
comprises a communication unit that receives user motion information from the user terminal, and
the motion information extraction unit
executes processing of extracting motion data search motion information from the user motion information received from the user terminal.

13. The information processing device according to claim 12, further comprising:
a motion data search unit that searches for motion data similar to the motion data search motion information on a basis of the motion data search motion information extracted by the motion information extraction unit.

14. The information processing device according to claim 12, wherein
the communication unit transmits, to the user terminal, motion data similar to the motion data search motion information that is a search result of a motion data search unit.

15. The information processing device according to claim 14, wherein the motion data as the search result transmitted to the user terminal is at least one of a motion data body, moving image data having a lower resolution and a smaller data size than the motion data body or a thumbnail image.

16. An information processing method executed in an information processing device, wherein
the information processing device includes a motion information extraction unit that extracts motion data search motion information from user motion information analyzed on a basis of sensor detection values of motion sensors worn on a plurality of parts of a body of a user, and
the information processing method comprises:
detecting, by the motion information extraction unit, identification poses of:
(p) search motion information start position identification pose; and
(q) search motion information end position identification pose,
from the user motion information, and extracting motion information between the detected identification poses as motion data search motion information.

17. The information processing method according to claim 16, wherein
the motion information extraction unit
detects two pose sets of:
a first pose set including (r) identification pose execution preliminary notification pose, and (p) search motion information start position identification pose; and
a second pose set including (r) identification pose execution preliminary notification pose, and (q) search motion information end position identification pose,
from the user motion information, and extracts motion information between the two detected pose sets as motion data search motion information.
